(19) United States
(12) Patent Application Publication
(10) Pub. No.: US 2010/0211416 A1
(43) Pub. Date: Aug. 19, 2010

(54) METHOD AND APPARATUS FOR HEALTHCARE FUNDING EXCHANGE

(76) Inventors: William Fielding Frank, Auburn, NH (US); Robert Martin Kaskel, Rockaway Park, NY (US); Susan Landin, Great Neck, NY (US); Richard J. Maier, Old Tappan, NJ (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/498,031

(22) Filed: Jul. 6, 2009

Related U.S. Application Data
(60) Provisional application No. 61/153,837, filed on Feb. 19, 2009.
(60) Provisional application No. 61/159,216, filed on Mar. 11, 2009.

(51) Int. Cl. G06Q 40/00; G06Q 10/00

(52) U.S. Cl. 705/4; 705/30; 705/36 R; 705/37

(57) ABSTRACT

A Healthcare Funding Exchange (“HFX”) is implemented as a business service domain of service components communicating with each other wherein the execution of a complete interaction with an external actor is effected by the combined performance of executions by the service components. Each component can operate independently of all the others, and can be accessed by the others through service requests conveyed by a service broker. A complete interaction with an actor external to the domain occurs by one component performing its role, providing a service response, and potentially also issuing new service requests to other components, either during or at the end of its own processing. The service components in a business service domain also all have access to data they may share. One component generally has the responsibility for changing any given element of the shared data, but any components may read it.

### CROSS REFERENCE TO RELATED APPLICATION

This application claims benefit of U.S. Provisional Application No. 61/153,837, filed Feb. 19, 2009 which is incorporated herein by reference in its entirety and U.S. Provisional Application No. 61/159,216, filed Mar. 11, 2009 which is incorporated herein by reference in its entity.

### FIELD OF THE INVENTION

The present invention relates to financial markets and more particularly to a system for providing efficient markets for healthcare funding.

### BACKGROUND OF THE INVENTION

Current medical expenses reached $2.4 trillion in 2008 and the industry keeps growing by leaps and bounds. Aggregate demand for medical services, hospitals, healthcare services, medical testing (e.g., MRI Centers, testing centers, etc.) and medical supplies keeps getting stronger, and can be expected to trend upwards as our population ages. However there is concern regarding the very high percentage of each dollar charged for such services that is earmarked for administrating and financing.

Managing a medically-related business is becoming more and more challenging as the claims for services mount both in number and cost. Medicare, Medicaid and third party insurance companies have put in place strict compensation guidelines in order to establish control over payouts. These guidelines result in smaller payouts for claims and longer waits.

On the other hand, operating expenses remain the same or perhaps are higher. There is still need to pay employees, facility expenses and suppliers. In almost all cases, the ability to achieve economies of scale to pursue new opportunities to grow are hampered by the severe impact upon operational cash flow, and the high cost and low availability of credit. In an increasing number of cases, the ability of hospitals to continue to operate is threatened. see p3, ins 11-16An increasing number of medical providers have been forced to turn to medical receivable factoring, at annualized rates in the 20% to almost 40% range. (Medical receivable factoring rates typically range from 2% to 3.5% per month.) .

FIG. 1 illustrates the interactions between players in the current environment in which medical receivables factoring works as follows. First, medical providers 102 submit claims to insurance companies 104, HMO's and Medicare/Medicaid. The medical providers 102 can then submit copies of the claims to the medical factoring company 106. Medical factors 106 buy the medical receivables and advance up to 85% of the net collectibles (a reserve of at least 15% is not advanced to offset discrepancies). Once the claims are paid, the transaction is settled and the medical provider 102 receives a rebate of any remaining reserves less fees from medical factors 106.

FIG. 1 also illustrates the use of bank loans to fund operations, which differs from the factoring scenario in that the receivables are not usually used as a basis for the loan at all. The lines of credit on which the loans are based are derived from the overall balance sheet of the hospital. This limits the size of the loans, and causes the rate of the loan to depend on the overall creditworthiness of the medical provider.

Today's Healthcare economics is very primitive, compared to the economic relationships and financial products used in oil or agriculture, even though health is a larger economic sector than either of the others (2.5 trillion last year, growing at 10% per year). In health care, pricing, settlement, and funding are all done in one-on-one agreements between the participants: hospitals, doctors, with the insurers calling most of the shots and the patients having the least say in the matter.

In the claims communications structure of today, communications about the claims and actual cash settlements are not synchronized with each other, resulting in high administrative costs. Even if healthcare information is better automated, it will still be massively redundant, and not change the basic flow of the business transactions.

As a result, there are major delays in payments: 60 days is normal, 90 days is not uncommon. At any point in time, there are $600 billion outstanding in unpaid collectables acknowledged by insurers. This is a result of the natural tug of war between the insurers who need the money for investment returns and the providers who need the money to service patients.

The providers loose, because they can't, today, fund the float at a fair price, due to the fact that the value of the receivables are not marketable, except as asset sales, while the actual risk in that $600 Billion is not much more than that on T-Bills, or less than one quarter percent, which the hospitals should be able to fund close to. Now, hospitals get a small part of their needs covered by banks at relatively high commercial rates, while financially troubled hospitals go to factors.

Of course, factoring is today serving important functions a significant benefit from factoring medical receivables is that cash flow becomes predictable, as opposed to waiting 30 to 90 days and hoping medical claims might possibly be paid sooner (or paid at all). Another benefit of medical factoring is that it grows with business. As opposed to traditional bank lines of credit that have fixed limits, medical receivables factoring, in theory, can finance as many claims as a provider can generate.

While there exist today marketplaces for medical providers to present their receivables to multiple bidding factors, the economic relationships are unchanged by these marketplaces. Each purchase of receivables is a bilateral agreement; there is no financial instrument created that is independent of the receivables themselves, and the settlement and servicing of the transaction is not centralized.

### SUMMARY OF THE INVENTION

Illustrative embodiments of the present invention provide an electronic marketplace or exchange to facilitate the issuance, sale, settlement and servicing of healthcare funding instruments such as those based on bundles of medical receivables. This electronic exchange provides a uniform, efficient process for replacing the factoring medical receivables and bank loans and will help increase the return on these assets and improve the associated cash flows for the medical providers. By securing liens as part of its settlement of trades, where appropriate, embodiments of the invention enable the conveyance of a perfected lien interest to the buyer. The efficiency of a transparent market offset the limitations in the existing financing models, bringing an exchange model to the front with its diverse universe of investors and traders, and its integration of cash and instrument settlement.

A medical claims exchange enables medical providers to offer their claim based receivables for issuance in bundles. These bundles provide the basis for financial instruments with associated terms and conditions. The instruments are provided on the marketplace and subject to a bidding process. In this process, buyers bid against each other and sellers can hit the bid they wish to execute a trade against. The market participants will determine the quality of the issuers' claims bundles and the discount levels at which offers and bids are submitted. The market can be supported by Government involvement as a market maker, as an underwriter, or by sponsorship of a trust/settlement agent of the issues. The instruments offered out for bid can be provided with certain historical data by which valuations may be performed. The market participants can then more accurately assess the value of the issues.

Another illustrative embodiment of the invention supports the centralized issuance, trading and servicing of instruments based on medical service credit bundles. These are bundles of pre-paid medical services.

Another illustrative embodiment of the invention enables financial instruments based on medical service claims bundlers and credit bundles to be issued, traded, and services together on the same marketplace, using similar processes and the same technology.

Integration with the existing medical claims clearinghouses facilitates the flow of claims data. Governmental authorities such as Secretaries of State support lien creation and modification. Transparency, accurate valuations, and the competitive nature of this marketplace directly impacts medical receivables funding by together working to drive down funding costs for providers.

Advantageously, the invention decreases and provides better control of the growth of current health care costs due to administrative overhead and financing and helps limit future cost increases. Illustrative embodiments of the invention do so by decreasing the cost of funding for health care providers and eliminating inherent delays in receiving monies due for services provided.

The size of a marketplace for bundles of medical receivables will drive the need for more sophisticated methodologies as buyers and sellers want more accurate valuations for the bidding process. The information on claims versus explanations of benefits will become increasingly valuable and will generate an additional revenue stream which can be shared with parties contributing to the information generation.

The ability to better regulate medical providers, health care insurers, and offer other improvements in health care financing will be enhanced by the operational functions based on this invention. First, the availability of historical data aids in regulation, enables the measurement of the effectiveness of programs, and monitors the behavior of insurers and medical providers. Second, the effectiveness of government insurance can be measured alongside that of private insurers and used as a yardstick for measuring the comparative effectiveness.

Since shortfalls in the current collection process must be made up as future services are rendered, the efficiency of a market-driven solution can reduce the rate of cost spiraling associated with these services. Depending upon the quality of filed medical claims, issuance of bundles through the inventive electronic marketplace will greatly cut the recovery costs for the medical providers. A by-product of the settlement process for trades according to the invention will eliminate the current delays in flow of cash to fund on-going operations and its consequential negative credit impact on medical providers.

Embodiments of the present invention provide a Healthcare Funding X-Change (HFX). HFX is a transparent, regulated marketplace for the exchange of monetized medical services such as Medical claims bundles and Medical service credit packs. Medical claims bundles represent the services already rendered by medical service providers in the form of sets of their receivables against their insurance claims. Medical service credit packs represent the services the providers are prepared to render in the future, in the form of guaranteed delivery of sets of pre-paid services. HFX integrates the issuance, execution, settlement, and servicing of the traded assets by providing a business service coordination utility which provides an electronic mechanism that makes use of existing trusted market capabilities, and encourages multiple entities to provide an ever growing array of new capabilities.

In the case of Medical Claims Bundles, HFX enables these assets to be either as traded as true sales, in the form of accounts, called Claims Bundle Accounts, or to form the basis for other financial instruments, each representing variants of different kinds of financial interests in the claims bundles. Collectively, the Claims Bundle Accounts and the other financial instruments are called Claims Bundle Instruments (CBIs). The common features of and distinctive features of each type of CBI are described in the detailed description of the invention. Illustrative embodiments of the invention enable the issuance, trading, settlement, and servicing of the instruments to be controlled by instrument definitions that are present in and modifiable in the software controlling the marketplace. Additional embodiments based on CBIs might include claims bundle financial prediction techniques and pricing mechanisms appropriate to the different markets.

In the case of Medical Service Credit Packs, HFX enables these assets to be traded as true sales, forming the foundation for various financial instruments that might be based on them. Other embodiments of the invention based on Medical Service Credit packs include the specifications and implementations for such financial instruments, as well as prediction and pricing techniques.

Together, Medical Claims Bundles and Medical Service Credit Packs are the two fundamental kinds of medical service assets. Other embodiments that construct new business relationships using both Medical Claims Bundles and Medical Service Credit Packs include fungible, tradable medical insurance.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a diagram of Current Medical Provider Financing of Claims Receivables and Bank Loans, according to the prior art;

FIG. 2 is a diagram of: Planned Issuance & Trading of Medical Claims and Service Credits Bundle Instruments, using HFX according to an illustrative embodiment of the invention;

FIG. 2A is a diagram of illustrating Special HFX Interactions for Managing Medical Credits Issuance according to an illustrative embodiment of the invention;

FIG. 3 is a diagram of: Healthcare Funding X-Change Stakeholders according to an illustrative embodiment of the invention;

FIG. 4 is a diagram of: Healthcare Funding X-Change Structure according to an illustrative embodiment of the invention;

FIG. 5 is a diagram of: X-Frames™ Service Domain Model—Generic Business Service Components according to an illustrative embodiment of the invention;

FIG. 6 is a diagram of: Business Service Domains Implemented on the X-Frames™ Platform;

FIG. 7 is a diagram of: The HFX Service Domain Model—a Specialization of X-Frames™ according to an illustrative embodiment of the invention;

FIG. 8 is a diagram of: Bundle Issuance (Primary Market) Subcomponent Design according to an illustrative embodiment of the invention;

FIG. 9 is a diagram of: Bundle Trading (Secondary Market) Subcomponent Design according to an illustrative embodiment of the invention;

FIG. 10 is a diagram of Bundle Settlement Subcomponent Design according to an illustrative embodiment of the invention;

FIG. 11 is a diagram of: Bundle Asset Servicing Subcomponent Design according to an illustrative embodiment of the invention;

FIG. 12 is a diagram of HFX Parties Manager Subcomponent Design according to an illustrative embodiment of the invention;

FIG. 12A is a diagram illustrating an HFX process for mapping instrument definitions to execution control according to an illustrative embodiment of the invention;

FIG. 12B is a diagram illustrating an HFX process for generating an instrument definition using templates according to an illustrative embodiment of the invention;

FIG. 12C is a diagram illustrating an HFX process for execution using definitions, features and rules according to an illustrative embodiment of the invention;

FIG. 13 is a diagram of Claims Bundle Instrument (CBI) financial products according to illustrative embodiments of the present invention;

FIG. 14 is a diagram illustrating roles played by parties involved with Claims Bundle Instruments according to illustrative embodiments of the invention.

FIG. 15 a diagram illustrating preconditions for claims bundles to underlie securities according to illustrative embodiment of the invention;

FIG. 16 is a diagram illustrating a mechanism for submitting claims in a bundle according to illustrative embodiments of the invention;

FIG. 17 is a diagram illustrating variations of processing liens on claims bundle instruments according to illustrative embodiments of the invention;

FIG. 18 is a diagram illustrating an embodiment of the invention in which an institutional focus is required;

FIG. 19 is a diagram illustrating typical keynotes of parties involved with a CBA according to an illustrative embodiment of the invention

FIG. 20 is a diagram illustrating typical key roles of parties involved in CBE according to an illustrative embodiment of the invention;

FIG. 21 is a diagram illustrating typical key roles of parties involved with a CBP according to illustrative embodiments of the invention;

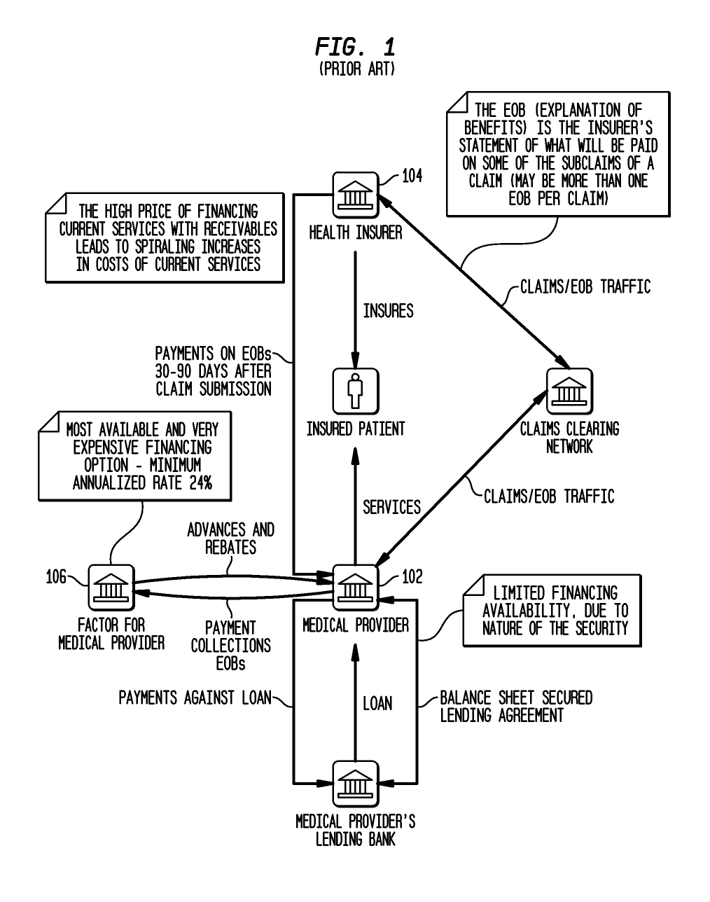

Table 1 is the hardware and system software for an illustrative embodiment of the invention;

Table 2 is the standard middleware for an illustrative embodiment of the invention;

Table 3 is specialized middleware for managing a service domain for an illustrative embodiment of the invention;

Table 4 provides a summary of several examples of embodiments according to the invention;

Table 5 is a table of Intrinsic Claims Bundle Attributes according to the invention;

Table 6 is a table of four variants of the CBE according to the invention;

Table 7 is a table listing of CBE subtypes, by payment types according to the invention;

Table 8 illustrates various ways in which one financial instrument in the CBI family may be used as the basis for another, according to the invention;

Table 9 illustrates Payments Dimensions and Parameter Values of CBI according to the invention;

Table 10 illustrates Instrument Contractual Dimensions and Parameter Values of CBI according to the invention;

Table 11 illustrates Bundle Element Feature Dimensions and Parameter Values of CBI according to the invention;

Table 12 illustrates Bundle Element Provider Dimensions and Parameter Values of CBI according to the invention; and

Table 13 illustrates Bundle Element Payer Dimensions and Parameter Values of CBI according to the invention.

### DETAILED DESCRIPTION OF THE INVENTION

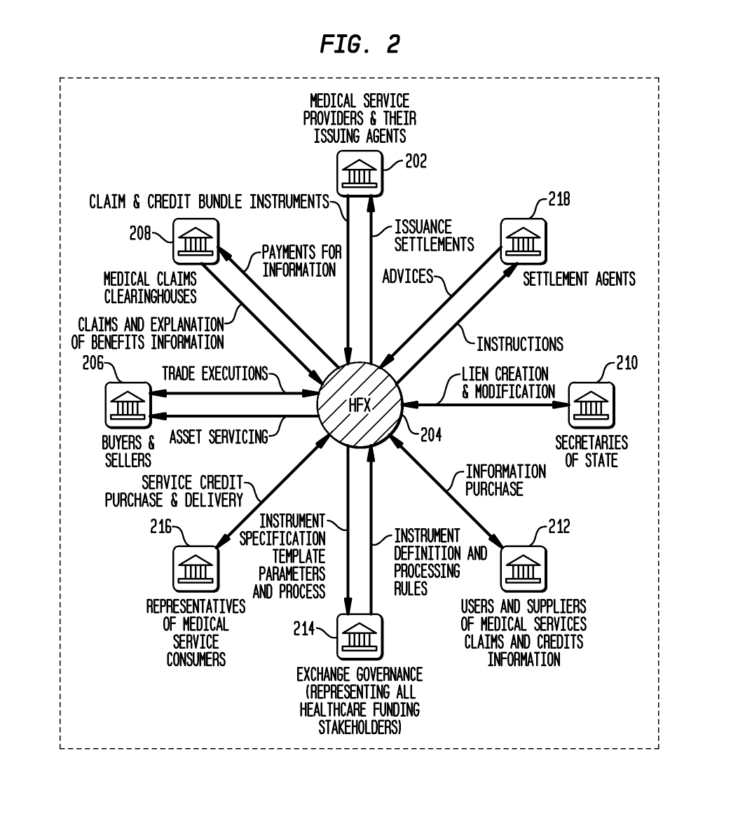

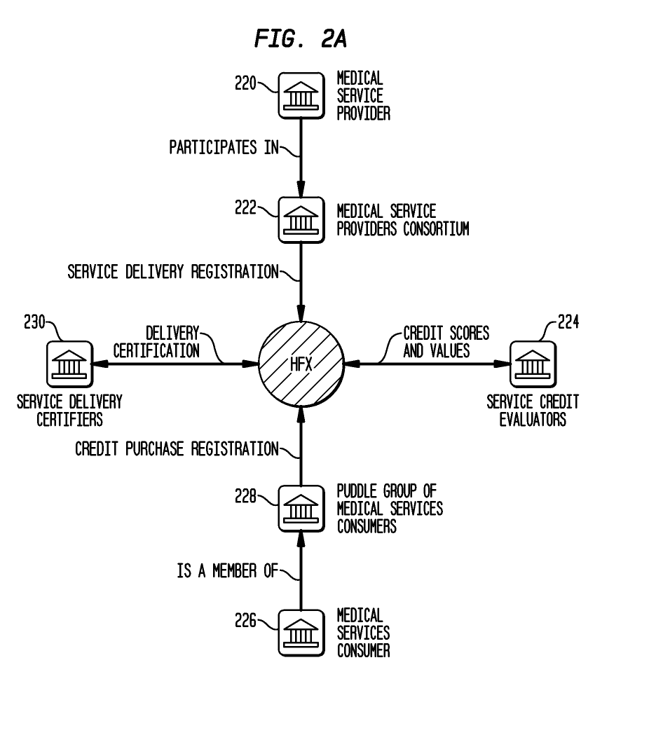

The various illustrative embodiments of the inventions are described with reference to the drawings in which FIG. 2 illustrates the interaction of the players engaging in planned issuance and trading of medical receivables and future cash services according to an illustrative embodiment of the invention. The present invention provides a medical receivables/claims exchange that enables medical providers to offer their claim based receivables and future cash services for issuance as bundles and offered to a bidding process 204. In this process, buyers bid against each other and sellers can accept the bid they wish to execute a trade against. The market will determine the quality of the issuer's instruments and the discount at which offers and bids are submitted. The instruments offered to bidders are provided with historical data by which valuations may then be performed. The buyers and sellers 206 will be able to accurately value the instruments.

Although some of the various illustrative embodiments of the invention are described herein with reference to claims and receivables, it should be understood that the various embodiments are also applicable to the trading of other medical financing instruments generally, including future cash services, for example.

The system supports issuance and trading of bundles of medical service credits and claims receivables, and the variations of financial instruments that can be defined, based on these assets. Integration with existing medical claims clearinghouses 208 supports the flow of claims data. Governmental authorities such as Secretaries of State 210 support lien creation and modification. Transparency, accurate valuations, and the competitive nature of this marketplace directly impacts medical receivables funding by significantly driving down funding costs towards a more realistic and workable level. Embodiments of the invention provide actual payment monitoring to the buy side of the market allowing claims from higher quality issuers (medical providers or intermediaries) to be funded at lower cost. This eases the current medical provider's burden of reconciling payments from explanations of benefits and reward medical providers for improving their claims processing.

Through the issuance or the writing of exchange trading contracts, service providers and issuing agents 202 transform the individual assets of the providers into standard marketable instruments for trading on the exchange. Illustrative embodiments of the present invention create a way of trading and settling medical claims, i.e., obligations between a medical service provider and a payer, in standardized bundles as financial instruments on an exchange. The embodiments replace private bilateral obligations with marketable instruments representing rights and obligations between the service provider and the payer.

The illustrative embodiments also create a way of trading and settling medical credits, i.e., bilateral agreements between a health care provider and a consumer, in standardized bundles as financial instruments on an exchange. The embodiments replace private arrangements for medical service forwards, for which the consumer pays up front, with publically traded contracts for medical service credit swaps or futures. Settlement agents 218 provide advice to and receive instruction from the HFX process 204.

Medical Claims Clearinghouses 208 serve as the mechanism by which health care providers communicate about insurance claims with insurers. In HFX, the clearinghouses also are a preferred party for providing the financial and payment performance related aspects of these claims to HFX, preserving the HIPPA compliant anonymity of the patients. Any party with the authority to provide this claims information could also play the role of claims data supplier. For example, the claims payer or the health care provider could play this role. The clearinghouses are a preferred party in this role party because they already have the ability to electronically route claims and related information between multiple providers and insurers. So, in the following, “claims clearinghouse” is the name used as a concrete stand-in for the general role of claims information provider.

Heretofore, the buyers and sellers 206 of health care financing have generally been only banks and factors participating in private bilateral deals with the providers. As a result, the deals are each unique, require unique definitions and maintenance, and are not easily comparable and are not resellable. In HFX, buyers and sellers will be buying and reselling fungible, standard deals.

Heretofore, deal settlement has been bilateral between the principals in the deals and their banks. In HFX, settlement services for claims and credits, however, is centralized into a few entities, most importantly decreasing settlement risk and also providing great economies of scale and settlement quality by eliminating the inefficiencies of bilateral settlement.

Heretofore, the sale of claims assets or future services has relied entirely on the trust of the selling institution and reliance on the fact that no other creditor has a right to these assets. UCC liens placed with state Secretaries of State, against claims bundles and credit bundles, as appropriate, perfect the settlement. While it has been proposed that medical insurance claims be liened, the cost of each lien has made this impractical. By placing liens against bundles, HFX eliminates this problem.

Heretofore, information about the delivery of health care services has been distributed among many thousands of locations, and held separately and inconsistently. Information about patients and other private information is comingled with information about services and their funding. HFX collects the non-private information concerning health care in a single place, for use not only by market participants, but by regulators and other evaluators of services and insurers.

Heretofore, medical service consumers 212 and or their representatives 216, unless they pay cash, have had access to health care services only through the intermediation of their individual insurance companies. These individual companies are placed in the middle of each service delivery, leading to an even more complex trilateral arrangement required for each service deliver. HFX enables consumers and their representatives to possess credits for services that disintermediates insurance in the service delivery transaction.

There are at least four ways in which claims bundles can be mapped to standardized financial instruments according to illustrative embodiments of the invention, namely, as asset sales, debt instruments, or derivative contracts of two sub-kinds. The ultimate mapping results depend on the regulatory venues, economic benefit and market demand. Illustrative embodiments of the invention also provide a way to map credit bundles to standard financial instruments, as derivative contracts. However, for both claims and credits instruments, the precise definitions of the instruments, including standardized delivery dates for contracts, for example, can ultimately be specified by the exchange on which the trading occurs, depending on regulatory requirements and the appetite of the buyers and sellers on the exchange. As a result, the HFX model features instrument definition itself as one of the standardized business processes of the exchange. This definition does not include the creation of a new capability for serving a new kind of financial need, but only the selection of parameters values from a template of parameters, to meet the detailed requirements of the exchange.

HFX includes the Exchange Governance body 214 as a participant in the exchange, whose role is to select, from the templates and parameters provided by HFX, those attributes the body wishes the instrument to posses. These definitions and rules then become part of the run time mechanism of the exchange, which uses them to direct its own processing.

In sum, the issuance of a medical service credits (a kind of futures contract) enables the medical providers to fund their future abilities now. Issuance of a medical service credit also enables the investors to bid for these service credits in large blocks and enables them to offer them to ‘patient groups’ in odd lots to satisfy claims for services. Patient Groups to be formed for multiple purposes include uninsured patients with some affiliation, partially insured patients (catastrophic coverage only) and self insured groups (businesses are now covering the deductible in exchange for lower premiums). Patient Groups can receive funds from government subsidies, charitable contributions and/or company funding. Claims submitted must be validated for meeting proper submission requirements and may be handled by existing insurance organizations. This presents an opportunity to standardize claims processing with the insured space, smooth out the service pricing with the insured and lower all claims processing unit cost by increasing the scale on which claims validation occur. Provider and Patient Group service unit utilization and accounting data will need to be available along with outstanding service units to help the issuer and investor determine appropriate offering and bidding.

Medical service providers and insurers may be rated according to their correct use of the claims and claims payment processes. There are several rating techniques already in use. For example, for Medicare Service Providers, there is the Comprehensive Error Rate Testing program (CERT), and for State Medicaid insurers, there is the Payment Error Rates Measurement (PERM).

The current purposes of these ratings are in support of regulations, self-help for medical service providers and insurers, and to help both medical service providers and the insured select insurers. The existence of a marketplace for medical receivables will put the force of economic interest behind rating programs and methodologies. More accurate and sophisticated methodologies will vie with each other as buyers and sellers want more accurate valuations for the receivables. The information on claims versus explanations of benefits held by the claims clearinghouses will become increasingly valuable, so the clearinghouses will have the incentive to provide this data.

The ability to regulate medical services, health care insurers, and other features of health care financing, is enhanced by the existence of HFX. First, the better rating data aids in regulation, enabling the measurement of the effectiveness of programs, and monitoring the behavior of insurers and medical providers in a way that brings them financial benefit. Second, the effectiveness of government insurance can be measured alongside that of private insurers, and used as a yardstick for the effectiveness of the private insurers.

Although the present invention is described generally with reference to the creation of instruments for the funding and settlement of claims and future services, it should be understood by persons skilled in the art that the HFX design may be extensible to support other kinds of health care funding needs such as the exchange of fungible health care insurance, for example.

According to an illustrative embodiment of the invention, an HFX is implemented as a business service domain. A service domain is a federated system of independently operating service components such as a human communications component, a computer communications component, a report and file extract manager, executor components for business objects and parties manager component, communicating with each other over a service broker, and using a standard service request language.

The execution of a complete interaction with an external actor, be that a person or a computer, is effected by the combined performance of executions by one or more of these service components. Unlike a traditional application, in which there is a single tightly coupled system of software elements, the HFX according to an embodiment of the invention is implemented in an X-Frames™ service domain, wherein each component can operate independently of all the others, and can only be accessed by the others through service requests, conveyed by the service broker.

Each service component is assigned a unique, non-overlapping responsibility (or purpose), for a certain type of processing—for example, handling reporting, or managing security prices. A service component's responsibility is embodied in the set of service requests that the component is capable of executing—for example, defining a new report type, running a report of that type, or changing a price. A complete interaction with an actor (external to the domain) occurs by one component performing its role, providing a service response, and potentially also issuing new service requests to other components, either during or at the end of its own processing.

Service components may be implemented on the same or different hardware platforms, as long as all are coordinated together via the business systems manager. The service components in a business service domain must also all have access to data they may share. One component generally has the responsibility for changing any given element of the shared data, but any components may read it.

Embodiments of the invention provide actual payment monitoring to the buy side of the market allowing claims from higher quality issuers (medical providers or intermediaries) to be funded at lower cost. This will ease the current medical provider's burden of reconciling payments from explanations of benefits and reward medical providers for improving their claims processing.

Medical service providers and insurers may be rated according to their correct use of the claims and claims payment processes, according to known rating techniques already. For example, for Medicare Service Providers, there is the Comprehensive Error Rate Testing program (CERT), and for State Medicaid insurers, there is the Payment Error Rates Measurement (PERM). The current purposes of these ratings are in support of regulations, self-help for medical service providers and insurers, and to help both medical service providers and the insured select insurers.

Referring to FIG. 2A, with the ability to pre-sell services, medical service providers 220 can better fund their ability to provide and plan the services. With the ability to pre-buy services at better prices, charitable organizations, corporations, and special interest groups, can offer better care to their people. Both medical service providers 220 and special interest consumer groups 228 are likely to form larger groups that together can provide more attractive credits and buy more flexibly.

Service provider consortiums 222 are consortiums of doctors' offices or of hospitals that offer credits that could be used by any of them, thus providing a more flexible bundle of credits for the consumption of large groups of consumers 226. Self-selecting, these consortiums 222 would have more common interests than, for example, the members of a given private insurance plan.

Pre-selling bundles of credits for medical services makes it desirable that the sellers be certified as possessing the creditworthiness to offer the services sold. This can be performed by service delivery certifiers 239, for example. Thus, to increase the value of services pre-sold, providers could offer evidence of their ability to supply services at a given rate—number of services per unit of time, or service delivery velocity—and as services credits were issued for use in a certain timeframe, the availability of the services would be checked by the system. Services sold for delivery in the further future would naturally be risk discounted against services for more immediate delivery, while at the same time; they might be assigned higher values as medical services were expected to increase in price.

The value of service providers' credits can be established by independent agencies 224, either in absolute terms or as ratings. Once delivered, the determination that the services provided are as claimed can be determined much in the same way that medical claims are validated by insurance companies. Indeed, public or private insurers can be the agents in these validations.

Government can also participate in this credit market, potentially offering universal health care without requiring radical, long-to-realize, potentially service quality dangerous changes in the current business structure of American health care systems.

According to illustrative embodiments of the invention, bundle of credits from a provider consortium can be sold to a consumer group on an open transparent, national market. This obviates the need for secondary funding, such as the issuance of bonds. The credit bundles themselves are the financial instruments in the marketplace. Therefore, the consumer puddles need not be the only investors in credits. Others may invest for the purpose of reselling credits to consumer groups at a later time. For example, investors may buy credits for use in the long future, and resell as they near execution.

The issuance of a medical service credits (a kind of futures contract) enables the medical providers to fund their future abilities now and enables the investors to bid for these service credits in large blocks and to offer them to ‘patient groups’ in odd lots to satisfy claims for services. It also enables Patient Groups to be formed for multiple purposes. Such patient groups include uninsured patients with some affiliation, partially insured patients and self insured groups. Patient Groups can receive funds from government subsidies, charitable contributions, and/or company funding. Claims submitted must be validated for meeting proper submission requirements and may be handled by existing insurance organizations.

The issuance of medical service credits also presents an opportunity to standardize claims processing with the insured space, smooth out the service pricing with the insured, lower all claims processing unit cost by increasing the scale on which claims validation occur. Provider and Patient Group service unit utilization and accounting data will need to be available along with outstanding service units to help the issuer and investor determine appropriate offering and bidding.

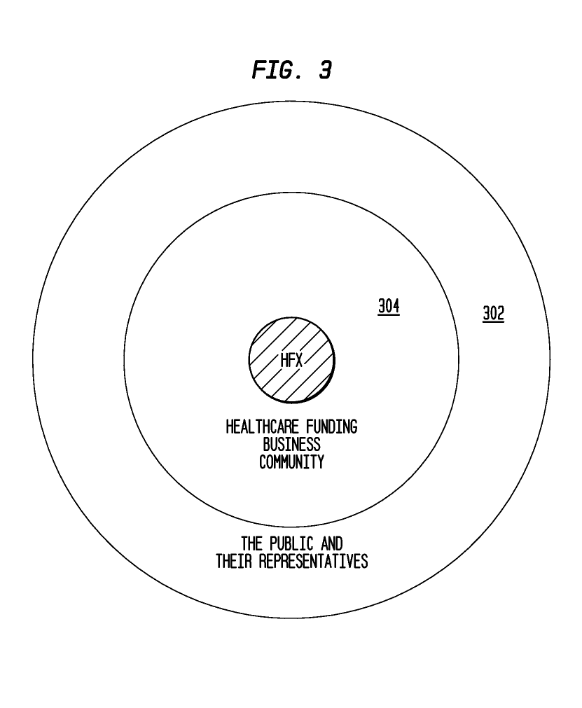

Healthcare funding X-change (HFX) stakeholders are described with reference to FIG. 3. The U.S. public and their representatives 302 are critical HFX stakeholders as the receivers of medical care and the ultimate reason for the existence of the business. The value of the services they receive, for the investment they make, depends in large part on the effectiveness of the interactions between the participants in the medical business community.

Stakeholders include individuals, government as representatives of the people, and interest groups of individuals, including businesses. Government representatives include state governments supporting special classes of insurance for the otherwise uninsured and Medicaid, and the national government. In its role as a regulator, government depends on the transparency of markets to insure fairness to their constituents. Interest groups include corporations that offer insurance and partial or complete self insurance to their employees, and charitable organizations that support specific groups of individuals.

The healthcare funding business community 304 is made up of all the parties that participate in HFX transactions and include, Medical Providers, Regulators, Insurers, Buyers and Sellers, Factors, Lenders, Claims Clearing Houses, Paying Agents, Lien Recorders (Secretaries of States), Valuation Services, Trustees, Custodians, Paying Agents, Trade Clearing Agents, and Investors in HFX. Government may play one or more of the roles above.

According to various illustrative embodiments of the invention, HFX is a “Service Domain.” A service domain generally includes a distributed, federated, extensible family of service components that support all the business activity required for the operation of some business. In illustrative embodiments of HFX, the business is the complete operation of the Healthcare Funding X-Change, for example.

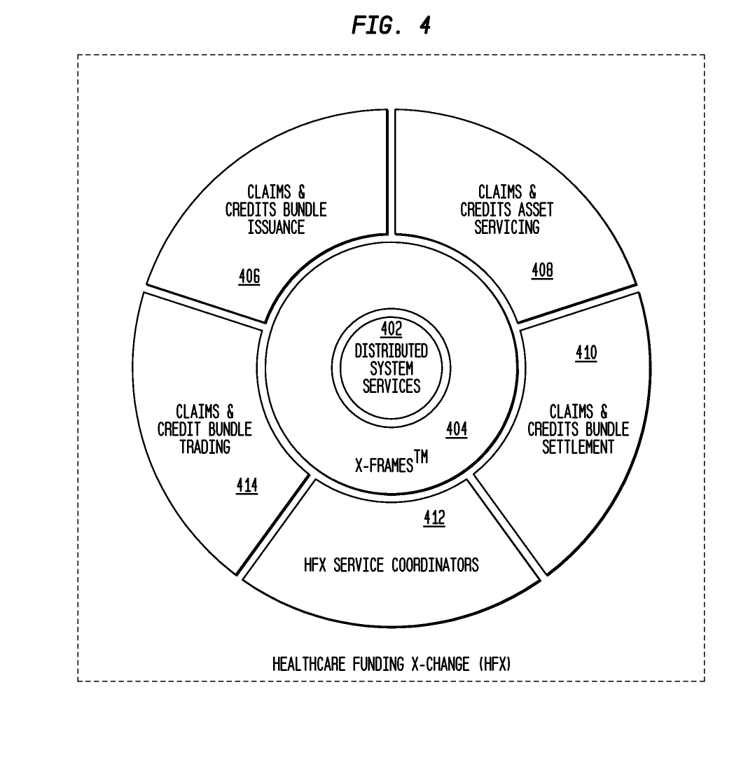

Illustrative embodiments of the invention provide an implementation of the business processes necessary for integrating the activities of all the participants. This implementation is structured into three layers, as illustrated in FIG. 4.

Distributed Systems Services 402 include the purchased and reused hardware and software products for HFX on which its service components are built. X-Frames™ 404, is a generic framework for implementing transaction-based, market-driven business domains, available from XTG, LLC, New York, N.Y. It enables a standardized structure and implementation of the service components specific to the given business service domain and includes a structure and methodology for creating service domain systems, and reference implementations of such systems. In an illustrative embodiment X-Frames provides a framework for building HFX, as described hereinafter (it should be appreciated that “X-Frames” from XTG, LLC is not affiliated with, related to or in any way an implementation of the XFrames specification for an XML application for composing documents together as promulgated by the WorldWideWeb Consortium).

HFX Service Domain includes the federation of the specific service components that perform the required HFX business Functions such as claims and credits bundle issuance 406, claims and credits asset serving 408, claims and credit bundle settlement 410, HFX service coordinator 412 and claims and credit bundle trading 414. Note that, as indicated in this diagram, the same service component of the HFX service domain handles both claims and credits. For example, there is one component for the issuance of both claims bundles and credit bundles. However, each bundle issued is either a bundle of claims or a bundle of credits. There is no single financial instrument that combines both claims and credits.

Distributed systems services are the services provided by the hardware and software products purchased for the implementation of HFX or any other X-Frames™ system. They provide the “platform” for implementing HFX. Such products are initially configured to be business domain-independent. They provide such technology services such as file and database management, transaction management, and computer process management.

Systems services are provided based on three sub-layers of technology platform, hardware and systems software; standard middleware; and service oriented middleware. Hardware and system software for the illustrative embodiments includes physical devices and the software that controls the physical devices (See Table 1);

Utilities and middleware includes the software that offers the technology services needed by business software, such as file, database, transaction, and communications management. Utilities and middleware are further divided into standard middleware required by any system (see Table 2); and service oriented middleware such as specialized middleware for managing a service domain (see Table 3).

For HFX or any X-Frames™ system, the platform technology for providing systems services is selected to support high availability, security, and high performance. For each category of technology, Tables 1-3 describe the requirements and the technology chosen for HFX, referred to as the “Reference Product.” The choice of specific technologies for implementation is open. As long as the requirements listed below are met, another product can be substituted for the reference product. The term “transactional” in Table 3 refers to the ability of the software, running on the hardware, to guarantee that a given, pre-identified, set of computer instructions always work correctly together, independently of any other events taking place in the distributed system, and are always correctly recoverable (i.e., are ACID—atomic, consistent, independent, and durable). X-Frames™ is XTG's framework for implementing transaction-based, market-driven business domains. It enables a standardized structure and implementation of the service components specific to the given business service domain.

X-Frames™ consists of a pattern for the types of service components to be used in an implementation, a specification of how the components interact to realize a service domain, specifications for each of the component types (whether from XTG or a 3rd party), specifications for specific XTG utilities and service components, and the methodology for using all of the above.

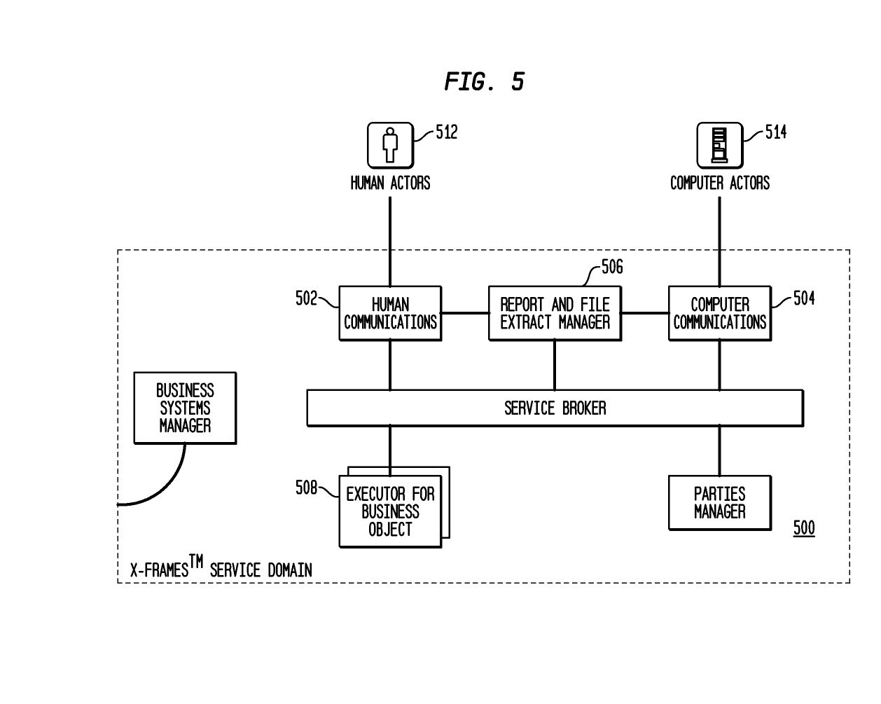

FIG. 5 illustrates the X-Frames™ pattern for implementing a business service domain according to the illustrative embodiments of HFX.

An X-Frames™ service domain 500 is a federated system of independently operating service components such as a human communications component 502, a computer communications component 504, a report and file extract manager 506, executor components for business objects 508 and parties manager component 510, communicating with each other over the service broker, and using a standard service request language that supports all the business activity required for the operation of a market-driven business community.

The execution of a complete interaction with an external actor, be that a person 512 or a computer 514, is effected by the combined performance of executions by one or more of these service components. Unlike a traditional application, in which there is a single tightly coupled system of software elements, in an X-Frames™ service domain, each component can operate independently of all the others, and can only be accessed by the others through service requests, conveyed by the service broker.

Each service component is assigned a unique, non-overlapping responsibility (or purpose), for a certain type of processing—for example, handling reporting, or managing security prices. A service component's responsibility is embodied in the set of service requests that the component is capable of executing—for example, defining a new report type, running a report of that type, or changing a price. A complete interaction with an actor (external to the domain) occurs by one component performing its role, providing a service response, and potentially also issuing new service requests to other components, either during or at the end of its own processing.

Service components may be implemented on the same or different hardware platforms, as long as all are coordinated together via the business systems manager and as long as there is either a shared database or data store coordination technology so that each service component may use the data managed by the other components. The service components in a business service domain must also all have access to data they may share. One component generally has the responsibility for changing any given element of the shared data, but any components may read it.

Responsibilities of each X-Frames™ service component types are described below.

A Service Broker component routes service requests from a requesting component to a service providing component, based on nature of the service request. The service broker isolates the requesting component from any knowledge of the identity of the providing component. Communications of service requests can have qualities—for example, service requests can be communicated with or without transactional integrity between components; service requests may be set to a single service provider, or they may be multicast or broadcast.

A Human Communications component renders between forms in which people can interact, such as using screens, keyboards, speaking, and reading reports, and the ways in which service requests are conveyed via the service broker. The Human Communication component translates human actions into service requests, and translates service responses into communications to people.

A Computer Communications component accepts computer communication from any of various protocols such as TCP Socket, WebSphere MQ, FTP, SFTP, HTTP, HTTPS, SMTP. The data conveyed may be of any of various data formats such as EDI, SWIFT, XML, MIME, binary, or any other format specification. The data is translated into a service request and sent to the service broker. Likewise, responses from the service broker are translated to the correct data format and sent via the appropriate protocol to the intended external computer system.

A Parties Manager component is responsible for correctly identifying and managing the information concerning parties that may have rights and obligations that parties may enter into in a market driven business domain and is responsible for the parties fulfilling such obligations. Both the entering into rights and obligations and fulfilling them are kinds of business transactions. Transaction-based market-driven business domains involve the execution of business transactions that change these rights and obligations, and record or execute their fulfillment. The Parties Manger component provides the means for identifying each party which must be referenced in the system, the descriptions of these parties and the relationships between them, the profiles for the use of business objects in the system by these parties. For example, the profiles that describe the accounts held by some of the parties in the system.

A market-driven business domain is concerned with the rights and obligations that parties enter into with each other, and their fulfilling those rights and obligations. Both the entering into rights and obligations (for example, via trading) and fulfilling them (for example, via trade settlement) are kinds of business transactions. Every transaction-based market-driven business domain involves the execution of business transactions that change these rights and obligations, and record or execute their fulfillment.

The parties manager is responsible for correctly identifying and managing the information concerning the parties that may have such rights and obligations.

An Executor for Business Object provides the execution of service requests resulting in the execution of business transactions between parties. Executor components implemented by XTG and to be used in HFX includes an X-Ecutor component and an X-Poster component. The X-Ecutor component is an implementation of an Executor that enables the execution of business transactions based on their specification as state transitions. The X-Poster component is an implementation of the database update responsibilities of an Executor that externalizes this responsibility and enables consistent reads of the data changed by the Executor.

A Business Systems Manager component provides the means for identifying the agents of parties e.g., people and computers who use the system on behalf of the parties, and for relating them to the parties they represent, and the profiles for the use of the system by these agents. This reflects the responsibility of the business system manager for managing the authorizations of the people and computers the system connects to, which must be done based on whom these actors represent. The Business Systems Manager does not relate parties to each other. The Business System Manger provides the monitoring capture and communication about the real time operation of the system, both from a business and technical point of view and the automated control of the business and technical operation of the system.

A Report and File Extract Manager component provides the means for defining report and file types for the system to generate, the generation of these report and file types, either on demand or according to a schedule and the delivery and display of this information.

The focus of the X-Frames™ framework is the service components that coordinate the business specific work of the Executors. The executors are defined specifically for each service domain. The coordinators, consisting of the Service Broker, Human Communications, Computer Communications, Report and File Extract Manager, Business Systems Manager together with the identify management provided by the Parties Manager, comprise the “glue” of the service domain.

A service component may itself be comprised of service components, each of which communicates with its sibling sub-components using the private service broker of the parent service component. This is the structure followed in HFX, where the components are provided with subcomponent designs that explain their behavior.

### X-Frames™ Implementations

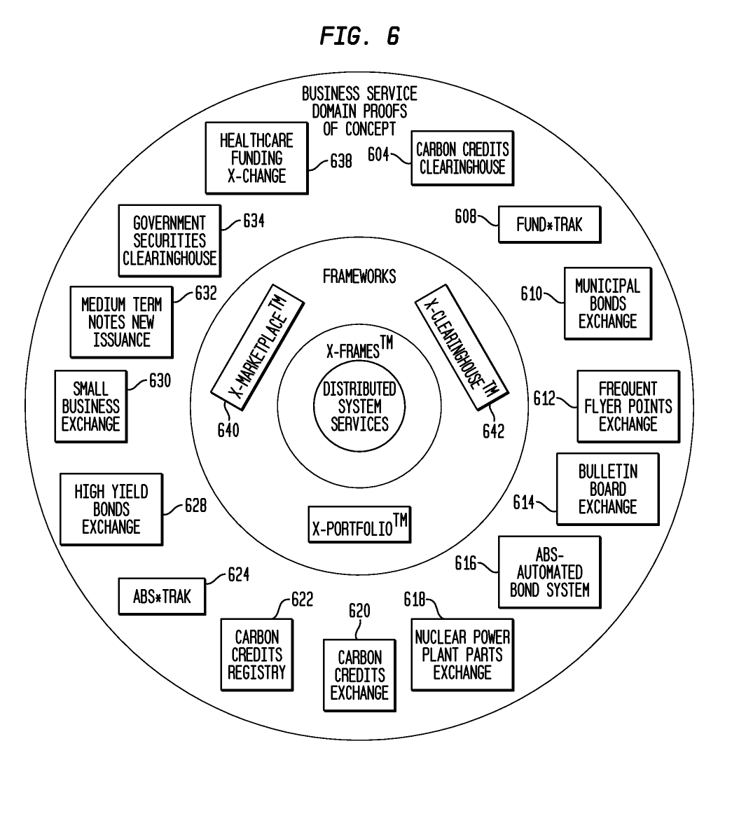

FIG. 6 illustrates, in its outer circle, several of the business service domains 602 that can be implemented in this way. Such business service domains include a Carbon Credit Clearinghouse 604, Fund Trak 608, Municipal Bonds Exchange 610, Frequent Flyer Points Exchange 612, Bulletin Board Exchange 614, Automated Bond System 616, Nuclear Power Plant Parts Exchange 618, Carbon Credits Exchange 620, Carbon Credits Registry 622, ABS Trak 624, High Yield Bonds Exchange 628, Small Business Exchange 630, Medium Term Notes New Issuance 632, Government Securities Clearinghouse 634 and Healthcare Funding X-Change 638. Each business service domain is implemented using a unique set of service components 630.

These implementations typically follow one of two general patterns, referred to herein as the X-Marketplace™ 640 and the X-Clearinghouse™ 642 patterns, for more specific aspects of market driven businesses. By way of examples as illustrated in FIG. 6, these aspects are most often provided by different specialized businesses. The X-Marketplace™ pattern 640 enables the exchange of business commitments between the participants. For example, managing purchases and sales, or trades. The X-Clearinghouse™ pattern 642 enables the settlement, or fulfillment, of the business commitments made in a marketplace such as managing the payments for purchases and recording of ownership changes resulting from sales. For example, the High Yield Bond Exchange is only a marketplace whereby it enables the trading of high yield bonds, but does not enable the clearing and settlement of traded high yield bonds. The Carbon Credits Clearinghouse 604 is only a clearinghouse which does not enable the issuance or trading of carbon credits. Illustrative embodiments of the present invention uniquely combine issuance, trading, settlement, and asset servicing in a single business domain.

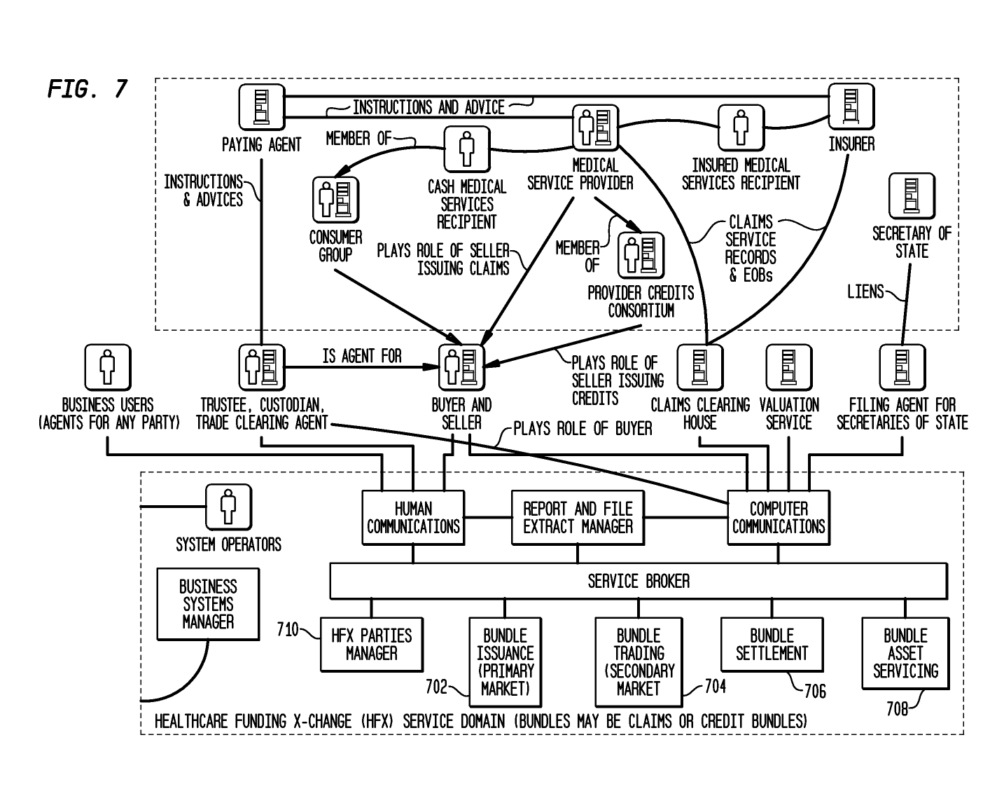

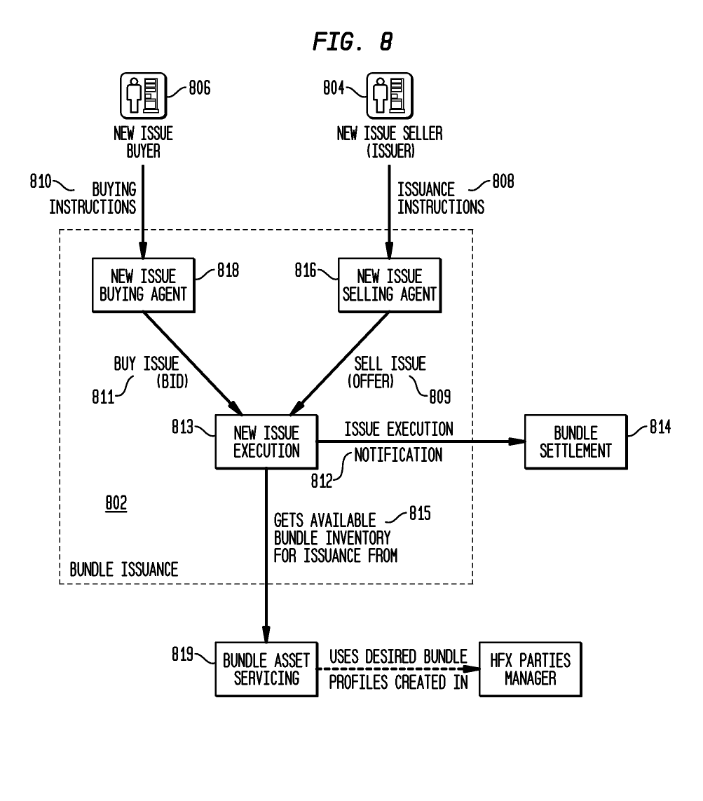

Specializations to support an illustrative embodiment of HFX are described and illustrated with reference to FIG. 7. The service components include the standard X-Frames™ coordinator component types and a business object executor for each of the special objects with which HFX is concerned, in certain of its states. The operation of each of these executor HFX components, and the special features of the HFX Parties Manager, are further described herein below with reference to FIGS. 8-12. Note that the functions required to support Claims Bundles and Credit Packs are often identical or similar. To simplify the descriptions, both Claims Bundles and Credit Packs are often called simply “Bundles”.

A bundle issuance component 702 enables issuers to identify bundles of their claims or packs of their credits (an issuer bundle) that a buyer may wish to acquire, and enables the execution of the issuance, by which the buyer agrees to the acquisition of the bundles from the issuer or issuers. A bundle trading component 704 brings potential buyers and sellers of already issued claims bundles together and enables them to execute trades. A bundle settlement component 706 coordinates the changes in the status of claims bundles and settlement payments between the trading parties as the result of the issuance of trading of claims bundles.

A bundle asset servicing component 708 manages the claims bundles and the payments they produce and creates the bundles for issuance. The claims bundle asset servicing component 708 also coordinates the payments for claims bundles from the issuers to the holders and concomitant changes in claims bundle value, based on Explanations of Benefits from Insurers. Ultimately, when all line items in a claim are paid, the claim is retired. When all the claims in a bundle are retired, the bundle is retired.

An HFX parties manager component 710 manages the identity, privileges, profiles, and accounting rules for all parties concerning whom information is tracked in HFX. This includes the direct parties such as Secretaries of State and insurers.

The service components that are shown in FIG. 7 to comprise the HFX service domain are described separately in more detail with reference to FIGS. 8-12. It should be used that the term bundle as described with reference to the figures herein generally refers to both bundles of claims and bundles of credits in the various illustrative embodiments of the invention.

As described with reference to FIG. 8, a bundle issuance (primary market component 802) enables Issuers 804 to identify bundles of their claims or packs of their credits (an issuer bundle) that a buyer may wish to acquire, and enables the execution of the issuance, by which the buyer 806 agrees to the acquisition of the bundles from the issuer or issuers. On the receipt of issuance instructions 808 from an issuer 804 (e.g., via a computer or from a workstation), if claims are available to construct the bundle, a claims bundle is defined and offered for sale 809 (e.g., via a computer message or from a workstation). If the issuer has sufficient unused creditworthiness, a credit pack is defined and offered for sale (e.g., via a computer message or from a workstation.) On the receipt of buying instructions 810 from a buyer 806 (e.g., via a computer message or from a workstation), if claims or claims bundles or credit packs are available to construct a bundle conforming to the buying instructions, the bundle is defined and bid 811 for purchase (e.g., provided to Issuer's computers based on subscriptions, or displayed on a workstation). Both the issuance instructions and the buying instructions may come directly from the agents of the parties 816, 818, or they may be standing new issue creation (for the issuer) and indication of interest (for the buyer) instructions, that are always in force, and are executed whenever the right kinds of claims are available to bundle and the other standing instruction conditions obtain.

When a claims bundle is defined by one or more issuers or a claims bundle defined by a buyer are available (e.g., the software contains these business objects), the issuer(s) and the buyer may agree to the sale (e.g., as commit messages from their respective computers or workstations). Similarly, the execution may take place because of an explicit agreement from agents of both trading parties, or take place automatically as a result of standing new issue execution instructions.

The issuance execution results in the HFX software generating a notification of execution 812 and sends this to Bundle Settlement 814 (e.g., as a service request). A new issue execution component 813 gets available bundle inventory 815 for issuance from a claims bundle asset servicing component 819. Bundle issuance is invoked when an issuer provides instructions to create and offer for sale a specific bundle of the issuer's claims or credits, (e.g., either by entering these instructions in a workstation or via a message from the issuer's computer). Issuance obtains an issuer's bundle from Bundle Asset Servicing 819, (e.g., by sending a service request to Bundle Asset Servicing 819 and receiving a notice that the claims bundle has been issued, and its identity, and then accessing the bundle from the database). This issuer's bundle is offered for sale on the Bundle Issuance market 802. (e.g., the New Issue Buying Agents 818 software in the HFX system, for each buyer is notified of the existence of the new bundle). Buyers who have subscribed to an interest in this kind of bundle are notified of its availability. (e.g., provided to Buyers' computers if they subscribe to offers of this type, or displayed on the workstation of a business user who is an agent of a buyer and requests to see offers of this type, by their respective New Issue Buying agents 818). This invocation may be by a software agent of the issuer or buyer, if they have provided standing instructions to invoke issuance transactions under given conditions. Bundle Issuance is invoked when a buyer indicates an interest in buying a bundle with given properties (e.g., either by entering these instructions in a workstation or via a message from the issuer's computer). Issuance obtains an owner's bundle from Bundle Asset Servicing 819 (e.g., by sending a service request to Bundle Asset Servicing 819 and receiving a notice that the bundle has been issued, and its identity, and then accessing the bundle from the database).

This owner's bundle is posted as an indication of interest on the Bundle Issuance market 802 (e.g., the New Issue Selling Agents software in the HFX system, for each issuer, are notified of the existence of the new bundle).

The issuers whose issuer bundles are included are notified of the indication of interest e.g., such notification may be provided to Issuer's computers if they subscribe to bids of this type or displayed on the workstation of a business user who is an agent of a issuer and requests to see bids of this type by their respective New Issue Selling Agents 816. This notification may be to a software agent of the issuer or buyer, if they have provided standing instructions to execute issuance transactions under given conditions.

One or more of the issuers may offer the issuer bundles in the indication of interest for sale (e.g., either by entering these instructions in a workstation or via a message from the issuer's computer). This offer may be made by a software agent of the issuer if they have provided standing instructions to execute issuance transactions under given conditions.

If there is a matching bid and an offer for the same owner's bundle, or a part of the owner's bundle that has been made available by issuers, and acceptable to the buyer, then the issuance is executed. For example, either the issuer or the buyer or both may submit, or one or both may submit their agreements to the issuance and purchase as commit messages from their respective computers, which are then accepted by the server systems. In both cases, the acceptance of the transaction is signaled back the workstations or computers. This bid and offer may be made by a software agent of the buyer if they have provided standing instructions to execute issuance transactions under given conditions.

The scenario ends when the notification of executions is sent to Bundle Settlement 814. (e.g., the HFX software generates a notification of execution and sending this as a service request to Bundle Settlement 814).

In an illustrative embodiment of the invention, an implementation platform for bundle issuance (primary market) component 802 may include hardware and operating system(s) implemented using IBM System p hardware running the AIX operating system; database management implemented using IBM DB2, ORACLE; Interprocess communications using IBM WebSphere MQ; business transaction execution using X-Ecutor; and persistence of business object state changes using X-Poser, for example.

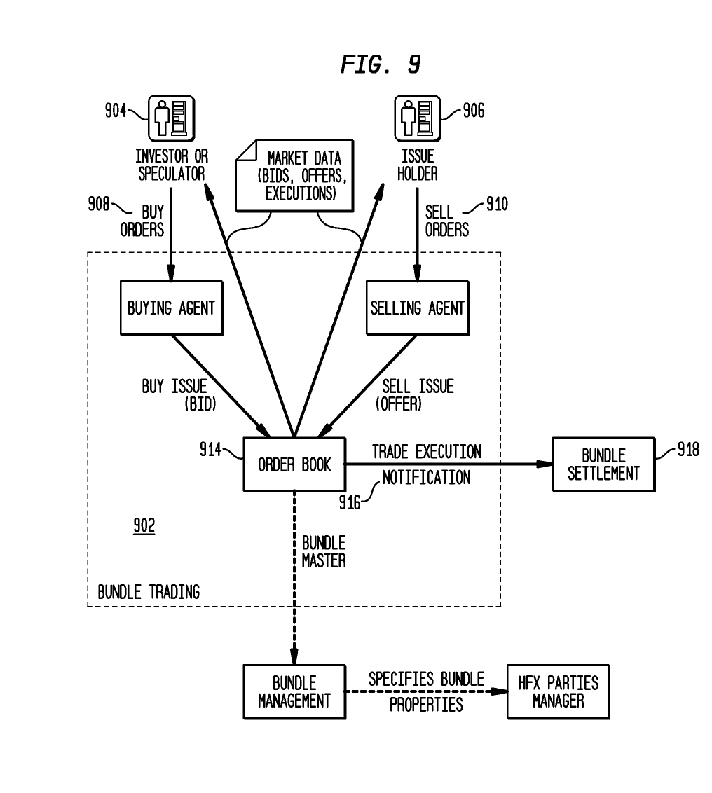

As described with reference to FIG. 9, a bundle trading (secondary market) component 902 brings potential buyers 904 and sellers 906 of already issued bundles together, and enables them to execute trades. The bundle trading (secondary market) component 902 accepts buy orders 908 from parties interested in purchasing and sell orders 910 from holders of issues for the purpose of matching buyers and sellers to execute trades (e.g., via computer messages or from workstations). The bundle trading (secondary market) component 902 enables the execution of the buys and sells when they match (e.g., via the database). Standard market rules for an orderly and fair market are applied. These rules are all configurable and are decided by the market regulator. These rules may include: matching rules for time and price priorities; sweeping rules, to allow for order parameters to be placed instead of a specific order causing the execution of a group of issues; and/or rules on firmness of orders, e.g., wherein, for example, an order must remain firm for 5 minutes when placing an order after which it may be allowed to become subject to acceptance.

The bundle trading component 902 also maintains and publishes an order book 914 of market data which consists of all open orders with their attributes, such as issue information, order time and order price along with execution data (e.g., via the database, computer messages, and workstation notifications).

The bundle trading component 902 also sends notifications 916 about execution to the primary parties and to Bundle Settlement 918 (e.g., via service requests, computer messages, and workstation notifications).

Bundle Trading is invoked when either an investor or issue holder submit a new order, modifies an existing order, or cancels an existing order (e.g., via a human interface or from the submitter's computer system via a computer interface). In an illustrative embodiment, the order is accepted and validated by the corresponding software agent, the Buying Agent for buy orders and the Selling Agent for sell orders (e.g., by performing a check on the semantic consistency of the order using a data dependency specification language). The valid order request is sent to the order book, (e.g., it is persisted into the database as an open order and held as a object).

The order book software attempts to match the two objects representing the new or modified order and an order on the opposite side. This means that an attempt is made to match, a buy order to an existing sell order within the order book based on the trading matching rules established by the market regulator and the matching tolerances of the buyer and seller. (e.g., matching rule specifications are made in a declarative language, such as a state transition or complex event processing language, and applied by the software). A match occurs when a buy order and sell order meet the requirements for matching, such as they are each the best bid and best offer and they are for the same issue. (e.g., this triggers a state transition to “Matched” or triggers and event). After a match is made, the buy and the sell are removed from the order book, (e.g., marked in the database as matched) and an execution object is created).

The buying and selling parties and the Bundle Settlement component are notified of the execution. (e.g., the Claims Bundle Trading software generates a notification of execution, and sends it as a service request to Claims Bundle Settlement, and to the agents of the buyer and seller, be these computers or people). An order cancel request removes an order from the order book (and correspondingly marks the order as canceled in the database). Investors, holders and other interested parties may collect market data by subscribing to a market data feed (e.g., by entering a subscription on a workstation or sending a subscription message from their computer).

This scenario ends in the illustrative embodiment after the entered new order, modified order, or cancelled order has been applied to the order book (and reflected in the database). It should be noted that execution history may be requested and is supplied by the HFX Report and File Extract Manager, but is outside of this scenario's usage.

In an illustrative embodiment of the invention, an implementation platform for bundle issuance (secondary market) component 902, such as described, may include hardware and operating system(s) implemented using IBM System p hardware running the AIX operating system; computer communications using IBM WebSphere Message Broker; human communications using IBM Lotus Expeditor, WebSphere Portlet Factory; database management implemented using IBM DB2, ORACLE; Interprocess communications using IBM WebSphere MQ; business transaction execution using X-Ecutor; and persistence of business object state changes using X-Poser, for example.

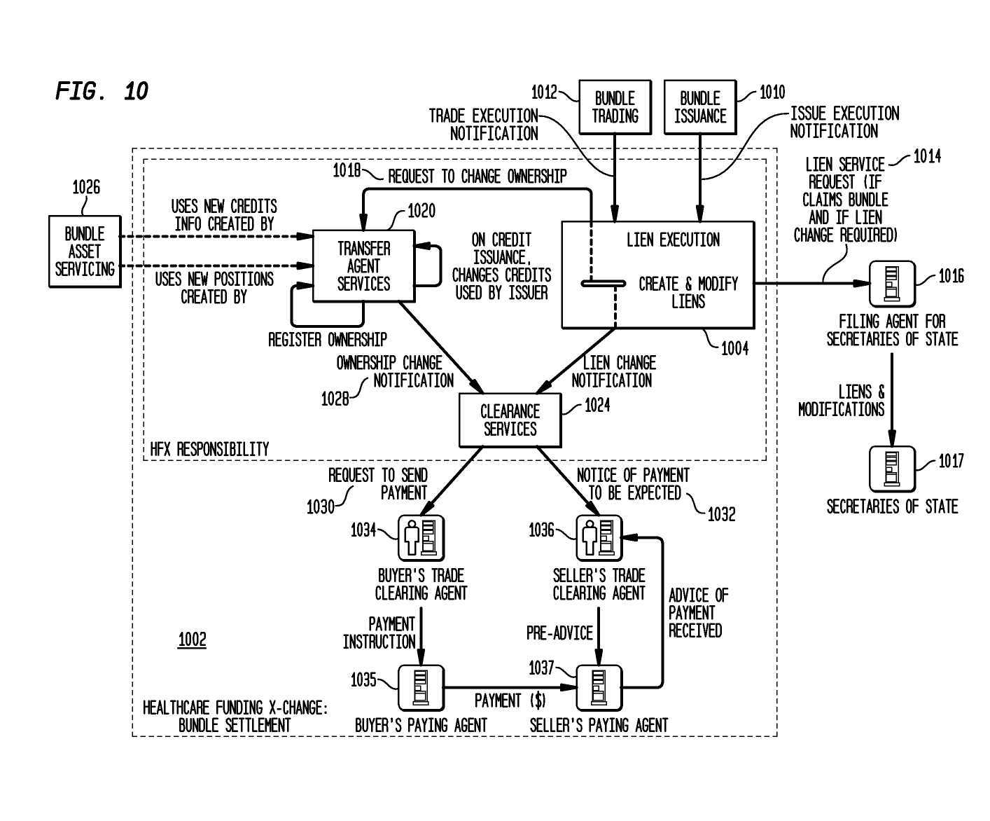

As described with reference to FIG. 10, a bundle settlement component 1002 coordinates the changes in the status of bundles and settlement payments, between the trading parties, as the result of the issuance or trading of claims and/or credit bundles.

The lien execution subcomponent 1004 places or revises a lien on the bundle in favor of the buyer, as authorized by the issuer, removing the lien, if existing, in favor of the previous bundle holder. (e.g., via computer messages and the database). In the case of claims bundles, when liens are a feature of the claims bundle instrument, these liens are communicated for registration and removal and sometimes for modification, with the secretary of state. In the case of credit bundles, if liens on future services are a feature of the service credit bundle instrument, these liens are recorded in the database, and not, under current UCC laws, registered, since liens on non-existent future property is not registerable, but only exists by agreement between the parties. Therefore, for service credit bundles, under current conditions, any liens associated with settlement are recorded only in the database.

The Bundle Settlement component 1002, via the Transfer Agent Services subcomponent 1020 also records transfer of ownership of the bundle instrument to the buyer from the issuer or seller (e.g., via the database) and coordinates the payment from the buyer to the issuer or seller, via the clearing agents of the two trading parties (e.g., via computer messages).

On a new issuance of a credit pack, the Transfer Agent Services subcomponent 1020 records a change in the credit outstanding for the issuer (e.g., via the database). A trading party might be self-clearing, meaning that they would serve as their own clearing agent Bundle settlement is invoked when the bundle settlement component 1002 receives a notification of execution 1006, 1008 from either bundle Issuance 1010 or bundle trading 1012. This notification may be received by the bundle settlement software component as a service request from bundle trading via the service broker, for example.

When the instrument is a claims bundle instrument, and liens changes are required by the instrument definition, Lien Execution subcomponent 1004 sends a lien request 1014, for an issuance, or a lien modification, for a trade, to a Filing Agent for a Secretary of State 1016 by sending a lien creation or modification request via the defined computer interface to the filing agent, for example. The Filing Agent 1016 communicates liens and modifications to the Secretary of State 1017. The lien change is confirmed by the Filing Agent 1016. A message may be returned via the defined computer interface of the filing agent, and the change to the lien status of the bundle is reflected in the database, for example.

The Lien Execution component 1004 sends a request for change of ownership 1018 to Transfer Agent Services 1020. A service request may be conveyed from the one subcomponent to the other via a service request broker internal to the Bundle Settlement component, or may be conveyed directly via a method invocation, for example. The Lien Execution component 1004 sends a lien change notification 1022 to Clearance Services 1024. Transfer Agent Services 1020 changes ownership of Bundle by changing the ownership association of the bundle from the one party to the other in the database, for example. This means that Asset Servicing 1026 will now see new owner of bundle for example, when the Asset Servicing component accesses the bundle in the database.

Transfer Agent Services 1020 sends an ownership change notification 1028 to Clearance Services. Upon receipt of both lien change notification 1022, (this notification is sent even if no lien change is required, indicating same) and ownership change notification 1028, Clearance Services 1024 sends matching requests to send payment 1030 and notifications of payments to be expected 1032, and notifications of ownership changes, to the buyer's clearing agent 1034 and seller's clearing agents 1036, for example, by sending computer messages to the computers of the two clearing agents, telling them respectively of the need to send the payment and the expectation to receive the payment. The buyer's clearing agent 1034 can send payment instructions to a buyer's paying agent 1035. The buyer's paying agent can provide payment to the seller's paying agent 1037 who can then advise the seller's clearing agent 1036 that payment was received.

The scenario ends when both clearing agents have acknowledged receipt, for example when Bundle settlement has received computer messages with these acknowledgements and stored them in the database.

In an illustrative embodiment of the invention, an implementation platform for bundle settlement component 1002 may include hardware and operating system(s) implemented using IBM System p hardware running the AIX operating system; database management implemented using IBM DB2, ORACLE; Interprocess communications using IBM WebSphere MQ; business transaction execution using X-Ecutor; and persistence of business object state changes using X-Poser, for example.

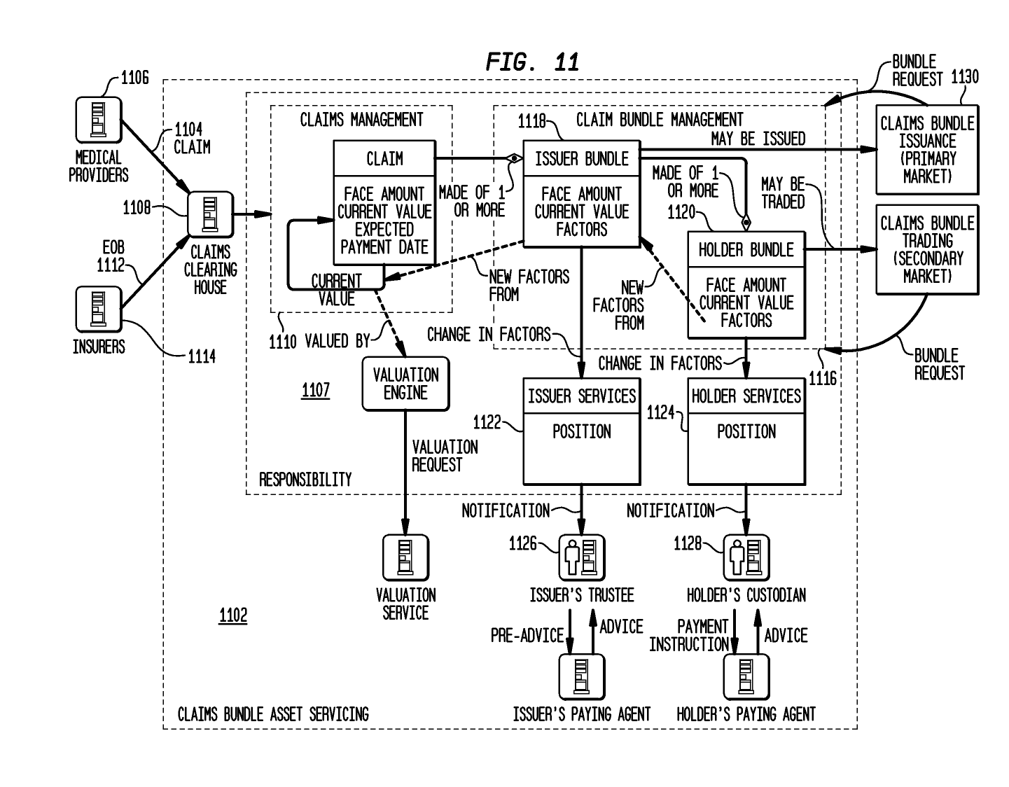

As described with reference to FIG. 11, a bundle asset servicing component 1102 manages the claims bundles instruments and the payments they produce, the credit packs and services they produce, creates the bundles for issuance, coordinates the payments for claims bundles, as they mature or as payments are made by payers, from the issuers to the holders, and tracks concomitant changes in bundle value, based on Explanations of Benefits from Insurers. Ultimately, when all line items in a claim are paid, the claim is retired. When all the claims in a bundle are retired, the bundle is retired.

For credits, this means coordinating the services delivered by the issuers against credit packs belonging to holders, and concomitant changes in credit pack value, based on service records from issuers. Ultimately, when all the services in a pack have been delivered or expired, the pack is retired. The bundle asset servicing component 1102 relies on the same external services to evaluate the legitimacy of service records as are used for evaluating claims (e.g., insurance companies).

On the receipt of a claim record from a claims clearinghouse the claims bundle asset servicing component 1102 makes the claim available for bundling (e.g., via the database and as a object). When a particular bundle has a potential buyer, the claims bundle asset servicing component 1102 creates the required issuer bundles and combines one or more issuer bundles into a holders bundle (e.g., as a object and via the database). A holder bundle may contain only one issuer bundle, for example. That issuer bundle becomes a part of the holder bundle.

If a valuation of the bundle other than its nominal value is desired, the claims bundle asset servicing component 1102 computes that value by obtaining a uniform set of claims valuations from some valuation service (e.g., via computer messages).

Upon declared intentions to pay by insurers, as provided in an Explanations Of Benefits (“EOB”), the claims bundle asset servicing component 1102 changes nominal and computed valuations, (e.g., by changing these values in the database) and informs issuers and holders of the forthcoming payments through their respective trustees and custodians (e.g., via computer messages). An issuer and a holder might play the role of their own trustee or custodian, for example. The claims bundle asset servicing component 1102 also provides current valuations used by the claims bundle trading marketplace (e.g., by recording these values in the database).

For credit packs, the bundle asset servicing component 1102 changes the value of the pack on the receipt of a record of a service delivery from a claims clearinghouse, (as the transmitter for the service provider) and forwards the service delivery record to an evaluation service, which determines the legitimacy of the service (e.g., via computer communications and a claims clearinghouse). If a valuation of the pack other than its nominal value is desired, the bundle asset servicing component 1102 computes that value by obtaining a uniform set of service valuations some valuation service. Upon change of ownership via settlement, nominal and computed valuations, (e.g., by changing these values in the database) the bundle asset servicing component 1102 informs issuers and holders of their respective rights and obligations to each other, vis-à-vis this packet.

Claims Management 1110 is first invoked when information on a new claim 1104 issued by a medical services provider 1106 is forwarded to HFX 1107 by a Claims Clearinghouse 1108. The information may be received, for example as a message through computer communications which is translated to a service request delivered by the Service Broker to the Claims Bundle Asset Servicing—Claims Management subcomponent). Information about the new claim is maintained by Claims Management 1110 pending and after its use in a bundle, for example by representing it as a object in the subcomponent and storing it in the database. Claims Management 1110 is invoked again when information about a payment on the claim is provided by an Insurer 1114, via an EOB 1112, and forwarded to HFX 1107 by a Claims Clearinghouse 1108. For example, the information is received as a message through computer communications which is translated to a service request delivered by the Service Broker to Claims Bundle Asset Servicing—Claims Management subcomponent.

When Claims Management 1110 received this new information, it changes the nominal value of the claim to which the EOB applies, (e.g., by storing the new value in the database) and, if this claim is a part of an issuers bundle, it signals Bundle Management 11 16 that one of its claims has changed value. A service request may be conveyed from the one subcomponent to the other via a service request broker internal to the Claims Bundle Asset Servicing component, or may be conveyed directly via a method invocation, for example. Bundle Management 1116 then changes the value of the Issuer's Bundle 1118 of which the claim is a part by changing the factor on the Issuer's Bundle (e.g., by storing this new value in the database).

If the Issuer's Bundle is part of a Holder's Bundle 1120, Bundle Management 1116 then changes the value of the Holder's Bundle of which the Issuer's Bundle is a part, by changing the factor on the Holder's Bundle (e.g., by storing this new value in the database). Bundle Management 1116 notifies Issuer Services 1122 of the new Issuer's Bundle Factor, for example via a service request that is conveyed from the one subcomponent to the other via a service request broker internal to the Claims Bundle Asset Servicing component, or is conveyed directly via a method invocation. Bundle Management 1116 notifies Holder Services 1124 of the new Issuer's Bundle Factor.

Upon notification of a new factor, Issuer Services 1122 notifies the issuer's trustee 1126 of the expectation to receive a payment from the insurer and the need to forward payment to the holder. This may be done by sending a computer message to the computer of the trustee, telling them to expect the payment and to send it on, and receiving and acknowledgement from the trustee. Upon notification of a new factor, Holder Services 1124 notifies the holder's custodian 1128 of the expectation to receive a payment from the issuer's trustee, for example, by sending a computer message to the computer of the custodian, telling them to expect the payment, and receiving and acknowledgement from the custodian.

The scenario ends when both Issuer Services and Holder Services have completed such as when the acknowledgements from the trustee and the custodian are both recorded in the database, for example.

Claims Bundle Management 1116 is first invoked when Claims Bundle Issuance 1130 sends a request for a new claims bundle to satisfy the needs of a buyer. For example, a service request may be conveyed from the subcomponent to the Claims Bundle Asset Servicing subcomponent via the Service Request Broker.

Claims from a single issuer that have not been bundled are bundled into an issuers bundle according to the parameters of the bundle request and following the profile for bundling provided by the issuer. This may be done by representing it as a object in the subcomponent and storing it in the database. If the buyer's request is for a bundle that includes bundlers from multiple issuers, then this step is repeated for each such issuer. (e.g., by the software following a specification for the bundle). The one or more issuer bundles are bundled into a holder's bundle for offer to the buyer, for example by representing it as a object in the subcomponent and storing it in the database. The illustrative claims bundling process ends when Claims Bundle Issuance 1130 is informed that the issuer's bundle(s) may be issued, and the holder's bundle may be traded. For example, a service request is conveyed from the Claims Bundling subcomponent to the Claims Bundle Issuance via the Service Request Broker. If the issuance is executed, then the issuer's bundles will be liened by Claims Bundle Settlement. Bundles already issued and held may be re-bundled into new holder's bundles if the current holder agrees to sell the bundle. The bundle asset servicing component 1102 also provides Service Credits Management and Credit Pack Maintenance.

Service Credits Management is first invoked when an issuer declares that they are providing a certain quality of credits of certain characteristics for issuance, or when they declare that they elect not to specify how many credits they may issue. This information may be forwarded to HFX by a Claims Clearinghouse or directly from the issuer. (e.g., is received as a message through computer communications which is translated to a service request delivered by the Service Broker to Bundle Asset Servicing - Service Credits Management subcomponent).

If there is no set number of credits to be issued by an issuer, then the credits used data in Service Credits Management is maintained for the issuer, but the credits available for use portion is not. If the issuer declares a fixed number and characteristics of credits available for issue in credit packs, then HFX may issue new credit packs automatically, based on this information and the issuer profile. If there is no set number of credits to be issued by an issuer, then the issuer cannot have HFX issue new credit packs automatically, based on its profile, but instead must manually create each new credit pack issue.

Information about the credits is maintained by Service Credits Management pending and after its use in a packet. (e.g., by representing it as an object in the subcomponent and storing it in the database). Service Credits Management is invoked again when information about the delivery of services by the issuer against credits is provided by the Issuer, in the form of a service delivery record, and forwarded to HFX by a Claims Clearinghouse. (e.g., is received as a message through computer communications which is translated to a service request delivered by the Service Broker to Bundle Asset Servicing—Service Credits Management subcomponent). When Service Credits Management receives this new information, it changes the number of the credits that the issuer has issued, (e.g., by storing the new value in the database) and, then it signals Credit Pack Management that one of its packs has been partially used. (e.g., a service request is conveyed from the one subcomponent to the other via a service request broker internal to the Bundle Asset Servicing component, or is conveyed directly via a method invocation). Credit Pack Management then obtains a verification of the service record from a verification agent, such as an insurance company. (e.g., by sending a computer message to the computer of the verifier, and receiving the verification in return.).

Credit Pack Management then changes the value of the Credit Pack to show remaining credits to be used (e.g., by storing this new value in the database). Credit Pack Management notifies Issuer Services and Holder Services of the change in the credits used in the pack. (e.g., a service request is conveyed from the one subcomponent to the other via a service request broker internal to the Bundle Asset Servicing component, or is conveyed directly via a method invocation). Holder Services notifies the holder's custodian of this change the value of the pack. (e.g., by sending a computer message to the computer of the custodian, and receiving and acknowledgement from the custodian). Issuer Services notifies the issuer's trustee of this change the value of the pack. (e.g., by sending a computer message to the computer of the trustee, and receiving and acknowledgement from the trustee.)

The illustrative scenario for bundle asset servicing of credit packs ends when both Issuer Services and Holder Services have completed. (e.g., when the acknowledgements from the trustee and the custodian are both recorded in the database).

Credit Pack Management is first invoked when Bundle Issuance sends a request for a new credit pack that an issuer of a buyer would like to see issued. (e.g., a service request is conveyed from the component to the Bundle Asset Servicing subcomponent via the Service Request Broker). If the issuer has established a set number of credits and characteristics that they will issue, and then Credit Pack Management uses that that information to determine the nature of the credit pack to be issued. (e.g., by referring to the information as recorded in the database, and by the software following the specifications for the issuer, buyer, and credits available for issue.) lb. If the issuer has not established a set number of credits and characteristics that they will issue, and then Credit Pack Management uses the description provided for that specific credit pack issue by the issuer. (e.g., by referring to service request from Bundle Issuance, which, in this case, must originate from an issuer, and not from a buyer).

The illustrative credit pack creation scenario ends when Credit Pack management creates the new credit pack (e.g., by representing it as an object in the subcomponent and storing it in the database) and sends a service response to Bundle Issuance with the identity of this new credit pack.

In an illustrative embodiment of the invention, an implementation platform for a bundle asset servicing component may include hardware and operating system(s) implemented using IBM System p hardware running the AIX operating system; database management implemented using IBM DB2, ORACLE; Interprocess communications using IBM WebSphere MQ; application specification/implementation using WebSphere Application Server; and persistence of business object state changes using X-Poser, for example.

### HFX Parties Manager

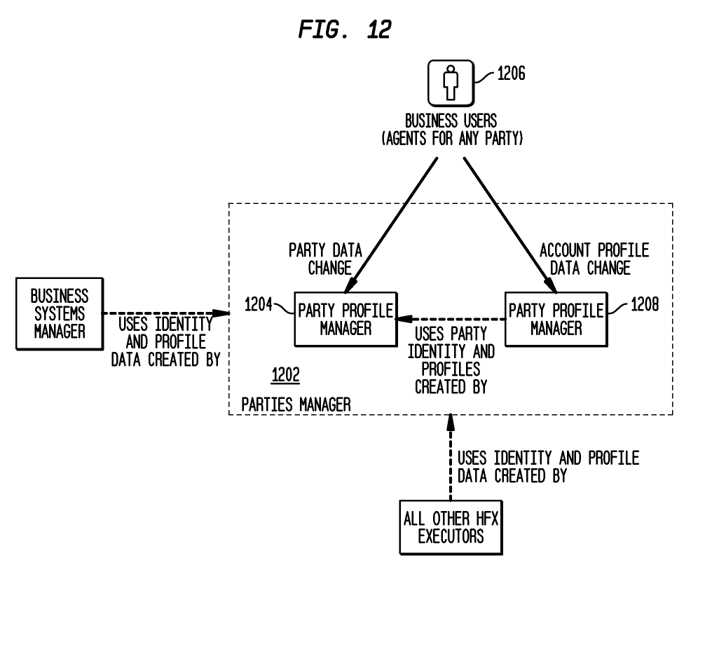

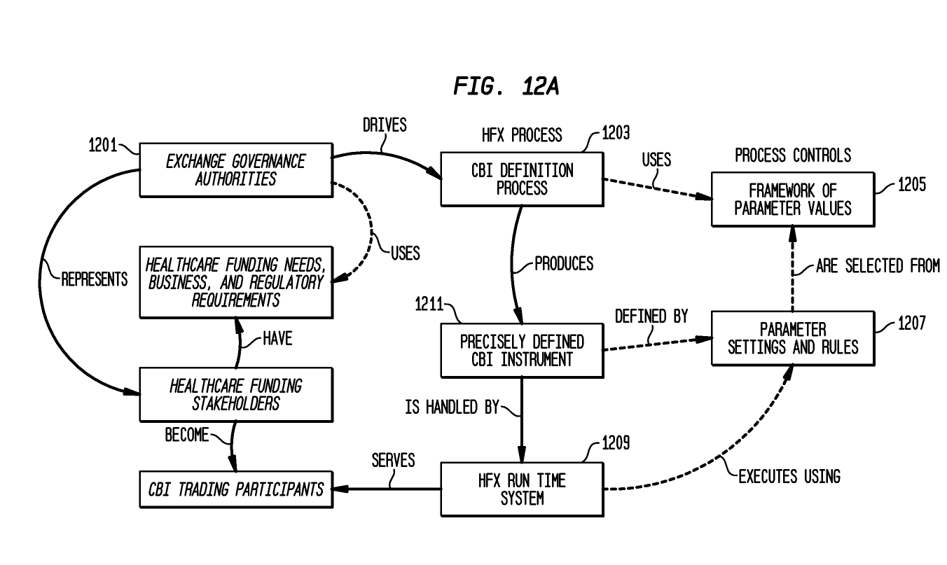

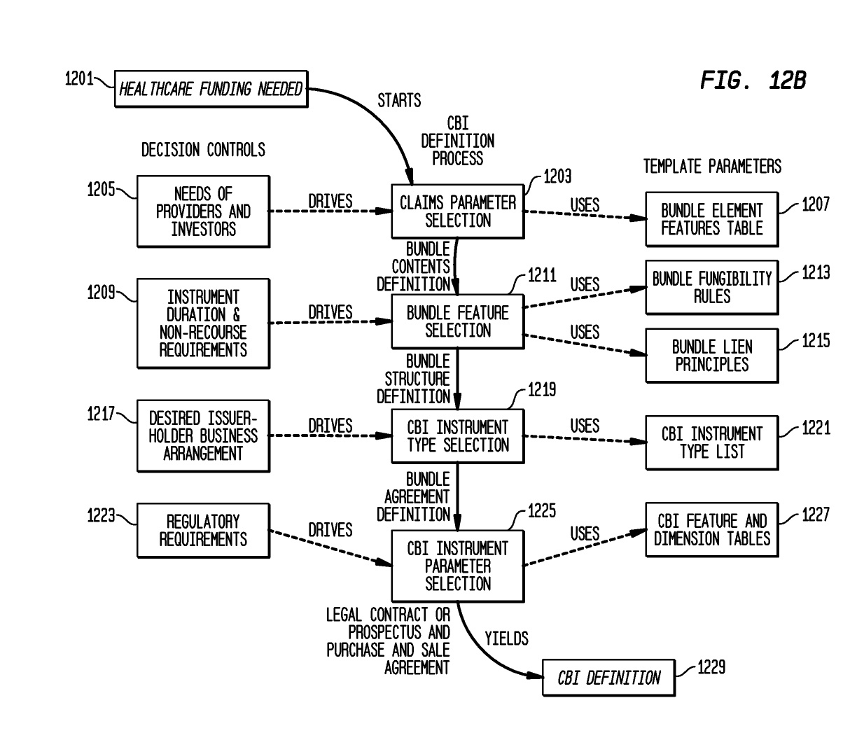

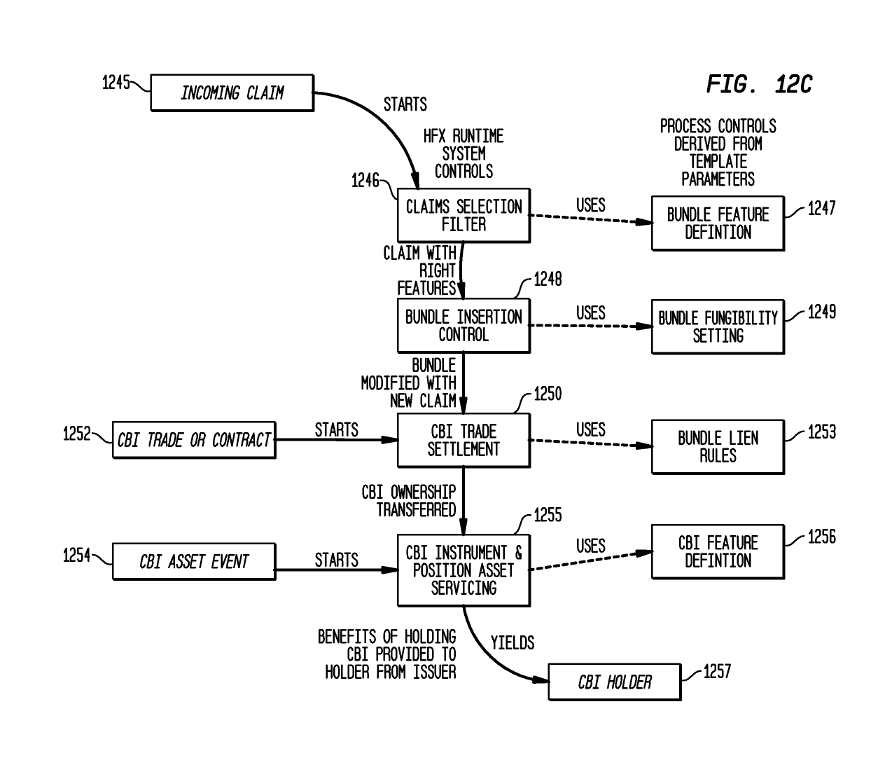

Referring now to FIG. 12, an HFX parties manager 1202 manages the identity, privileges, profiles, and accounting rules for all parties concerning whom information is tracked in HFX. This includes the direct parties, such as issuers and traders and claims clearinghouses, and the indirect parties such as secretaries of state and insurers. An insurer may also play a role as a trader, in which role they are a direct party. A party in this business domain is usually an institution. The identity and privileges of individual actors, who are always people or computers, with the institutions for whom they are acting as agents, is maintained in the Business Systems management component.

The Parties Manager enables new parties to be described to the system, and their profiles recorded, for example, by storing these profiles in the database). A profile is a set of special kinds of “Business Rules”. Each rule in a profile is a rule that can be set by a party that determines how a given business object will behave. For example, a given issuer might indicate in its profile that issues can be automatically created and sold on behalf of that issuer. Another issuer might indicate in its profile that issues can be sold only on specific issue approval from the issuer. For example, a given secretary of state will have a specific daily cut off time for the receipt of lien requests, as well as specific holidays when not operating.

The Parties Manager enables the set up of any accounts appropriate for the type of the party, for example, by storing the information about these accounts in the database. For example, an issuing hospital may have one or more accounts holding the issuer's claims and issuers claim bundles. Multiple accounts are allowed so that there may be separate rules for the holdings in each account. For example, an issuer may want separate accounts for claims against different insurers, with a rule that limits the nominal money amount of active bundles for a given insurer. As another example, a claims clearinghouse may have an account showing the amount due the clearinghouse for information provided.

In its initial operation, all changes to party data must be performed by people, for example, by their interacting with the system using workstations. In the illustrative embodiments of HFX, all data is available for reading from any component. The parties manager is responsible only for all changes to parties data. Parties profile data is used by other components simply by accessing the data directly. Over time, as security policies permit, some of these may be replicated by interactions with external computers.

The Party Profile Manager 1204 is invoked when an authorized business user 1206 indicates that it wants to create, delete, or change information about a party, such as by gesturing on their workstation that they wish to do so, for example. The system then displays a form for the creation of the party, or a form containing the information about the party to be changed or deleted. This can be done by Human Communications responding to this gesture with the required display, for example. The user 1206 then makes the desired additions or changes and commits these changes. Such changes can be performed by Human Communications interacting with the user, by translating into a service request by Human Communications, and by the Service Broker transmitting this service request to the Party Profile Manager 1204 subcomponent of the Party Manager 1202, for example.

The Party Profile Manager 1204 determines that the changes are consistent with the referential integrity of the data in the system, by following the integrity specifications in the PL/SQL of a Message Broker data access node. The system changes the data concerning parties by committing these changes to the database.

The illustrative party data change scenario ends when the user 1206 is notified that the changes have been committed, for example, by the Party Profile Manager 1204 subcomponent of the Party Manager 1202 providing a service request to the Service Broker, which transmits the request to Human Communications, which in turn renders it and displays it to the user.

The Accounts Profile Manager 1208 is invoked when an authorized business user 1206 indicates that they want to create, delete, or change information about an account, for example, by indicating or otherwise gesturing on their workstation that they wish to do so. This must include the identity of the party that holds the account. The system then displays a form for the creation of the account such as by Human Communications responding to this gesture with the required display.

The user 1206 then makes the desired additions or changes, and commits these changes, for example, by Human Communications interacting with the user, by translating into a service request by Human Communications, and by the Service Broker transmitting this service request to the Account Profile Manager 1208 subcomponent of the Party Manager 1202. The system determines that the changes are consistent with the referential integrity of the data in the system, for example, by following the integrity specifications in the PL/SQL of a Message Broker data access node. The system changes the data concerning the account by committing these changes to the database. The illustrative account profile data change scenario ends when the user is notified that the changes have been committed, for example, by the Account Profile Manager 1208 subcomponent of the Party Manager 1202 providing a service request to the Service Broker, which transmits the request to Human Communications, which in turn renders it and displays it to the user.

In an illustrative embodiment of the invention, an implementation platform for claims bundle issuance (primary market) component may include hardware and operating system(s) implemented using IBM System p hardware running the AIX operating system; database management implemented using IBM DB2, ORACLE; Interprocess communications using IBM WebSphere MQ; service request communications using WebSphereMessage Broker; and persistence of business object state changes using XTG X-Poser, for example.

Various embodiments of the present invention, as described in detail hereinbefore, are described with reference to particular examples described below. Table 4 provides a summary of several examples of the embodiments.

The entities responsible for Exchange Governance, such as government regulators and the management of the exchange, play the final role in determining what specific HFX instruments will be offered on the exchange for which they are responsible. This determination is done by using the instrument specification templates and parameters supplied by HFX for the types of health care funding instruments it supports, and selecting the parameter values that suit the needs of the market participants and regulators. These values are fed into the HFX, to guide and control the execution of issuance, trades, settlement, and asset servicing.

Referring to FIG. 12A, the Exchange Governance Authorities 1201 provide their controlling inputs to the CBI Definition Process 1203, which selects the appropriate values from the framework of CBI parameters. These selections then become the Parameter Settings and Rules 1207, which the execution of the HFX system software 1209. It is through this mapping process that the Funding Stakeholders' health care funding related needs supported in the HFX marketplace.

The Framework of Parameter Values, comprising tables 9 thru 13, will be maintained via computer in HFX, for example, in a database. These will be displayed both via a screen and via paper reports, to the business analysts operating the process on behalf of the Governance Authorities, who will select the options that reflect the intentions of the Authorities. The selected settings and rules are then stored, based on the selection, in another part of the database, from where they are accessed for execution.

The CBI definition Process enables HFX to generate a specific CBI definition 1211, based on the selections of the governance authorities. This generation takes place in several separate steps, as depicted in FIG. 12B. A healthcare funding need 1201 starts a claims parameter selection 1203. Needs of providers and investors 1205 drive the claims parameter selection 1203 which uses bundle element feature tables 1207 to generate a bundle contents definition. Instrument duration and non-recourse requirements 1209 drive bundle feature selection 1211 which uses bundle fungibility rules 1213 and bundle lien principles 1215 to generate a bundle structure definition. Desired issuer-holder business arrangements 1217 drive CBI instrument type selection 1219 using a CBI instrument type list 1221 to generate a bundle agreement definition. Regulatory requirements 1223 drive CBI instrument parameter selection 1225 using CBI features and dimension tables 1227 to generate a legal contract or prospectus and purchase and sale agreement. The CBI instrument parameter selection 1225 yields a CBI definition 1229.

In illustrative embodiments of the invention, the HFX Runtime System is driven by instrument definitions. Each function that is so driven is described with reference to FIG. 12C. An incoming claim 1245 starts a claim selection filter 1246. The claim selection filter uses a bundle feature definition 1247. Claims with correct features are provided by the claims selection filter 1246 to the bundle insertion control 1248. The bundle insertion control uses bundle fungibility settings 1249. A bundle modified with the new claim is provided by the bundle insertion control 1248 to CBI trade settlement 1250. A CBI trade or contract 1252 starts the CBI trade settlement 1250 which uses bundle lien rules 1253 to settle the trade or contract 1252. A CBI asset event 1254 starts CBI instrument and position asset servicing 1255 which uses CBI features definitions 1256. The CBI instrument and position asset servicing provides benefits of holding the CBI to a CBI holder 1257 from the issuer.

The Claims Selection Filter 1246 is the part of Bundle Issuance that determines whether a claim matches one or more bundle profiles, or bundle feature definitions, so that it can be selected for potential inclusion in one or more bundles.

The Bundle Insertion Control 1248 is the part of Bundle Issuance that determines whether a claim that meets the features required for the bundle will be inserted in the bundle. If the bundle is not fungible, then the specified initial net value size of the bundle is used to make this determination. If the bundle is fungible, is fungible then the current net value of the bundle is used to make this determination.

CBI Trade Settlement 1250 is the part of Bundle Settlement that determines whether the bundle has a lien on issuance, and whether it is re-liened when resold.

CBI Instrument and Position Asset Servicing 1255 is the part of Bundle Asset Servicing that determines how and when payments are made to the instrument holders.

### Claims Bundle Entitlement (CBE) Examples

Each of the examples address economic opportunity to realize significant savings associated with the tug of war for working capital between providers and payers, that results from the enormous and increasing cost of healthcare in the US. Healthcare Funding eXchange (HFX) embodiments expect financial engineers, the marketplace, and regulators to evolve the Claims Bundle Instruments (CBI) to those that prove most useful, using the instrument definition framework to select those features. To that end, these examples describe only the dimensions along which variables could be set to define a large variety of Claims Bundle Instruments, using the processing and technology described herein.

An ideal environment for HFX is via issuance through a government sponsored entity or other special purpose entity supported by a national exchange. However, HFX will also support the private issuance of a single member of the CBI family, with a single set of features. The example below covers an example initial private placement instrument.

An illustrative CBI family member provides a short term, non-fungible, fixed payment amount, variable payment period, fixed final settlement date instrument, a perfected Claims Bundle Entitlement (CBE), with a single provider. This CBE is a short term instrument with a declared net value but actual payments made as passed through from the claims as paid. The guarantee is that the funds due will be paid on or before the declared delivery date of the contract. This CBE uses the excess claims value protection method, and also uses the excess claims in the bundle to be able to guarantee a fixed final delivery date.

This illustrative CBE conveys a guaranteed right to the payments from a given, pre-defined claims bundle, without direct ownership of the claims in the bundle themselves. The CBE also conveys a declared net value [the amount to be paid to the holder of the CBE is predefined, independently of the amounts actual payments made] to be made by the final delivery date of the bundle. The issuer is ultimately responsible for the instrument, not the claims payer.

This CBE also conveys a commitment to make the payments to the holder of the CBE when they are actually made by the payer, rather than at some contractually pre-determined time(s). The CBE also conveys an assurance that the declared net value is protected by bundling a set of claims whose total net value is in excess of the guaranteed amount, to a degree that historically will be sufficient to ensure that the declared amount will be paid by the bundle by the completion date.

This illustrative CBE also conveys the rights of payments assigned to the holder without recourse by a lien against the entitled payments on the claim (a perfected instrument).

A CBE could be issued either by a bank or an insurance company, or a special-purpose vehicle, (SPV) on behalf of the provider whose claims are bundled together. If the CBE is issued by an insurer, such as Blue Cross/Blue Shield of Massachusetts, or Massachusetts Medicaid, it will be only for claims against that insurer. If issued by a bank or a SPV, this trust institution might purchase claims bundles from the individual providers as Claims Bundle Assets, either first, or as part of the same business transaction as the initial sale of the CBE, in order both to improve the balance sheet of the provider, and protect the CBE from providers' creditors.

Assuming a fixed face value of such an instrument is $1,000,000, it will correspond with a single claims bundle, whose net value will be some specific amount over the face value. The amount over the face value will be a function of the provider's claim payment experience with the payer. Once the $1,000,000 is paid to the holder, the remaining payments on claims will be made to the provider. In future, there may be larger instrument denominations, such as $10,000,000, and there may be multiple contracts, such as 10 contracts, each in a $1,000,000 denomination, against a single claims bundle with a corresponding net claims value. This CBE is identified according to its unique issuer, (as well as other of its attributes), so that it is not fungible with CBEs from other issuers.

Fungibility of CBIs is a highly desirable trait, and the structuring to enable it is described herein, although this is example is non-fungible.

This instrument will have a declared delivery date of 90 days after contract issue date, but duration of only about 60 days, given that most payments will be made prior to the delivery date. Assuming the instrument was bought at a price as if it were a 90-day instrument, with a 90 day duration it provides a slightly better value.

Along a payment timing dimension, alternatively, the instrument could be featured with a contractual payment at the end of the 90 days, with the asset servicer holding the moneys in escrow for the instrument holder(s) as they come in from the claims payers. This contractual payment CBE is simpler to value accurately and provides simpler recordkeeping for the holder(s), but is more complex for the issue servicer, and would have a lower yield for the investor, so was not chosen as the initial feature for the instrument to exhibit.

“Single Provider” generally means all the claims will be from a single hospital or a single family of hospitals with the same owner. Along a provider homogeneity dimension, Single Provider was chosen over Multiple Provider for the example issue type because fixed payment amount instruments based on “Multiple Providers” are more complex to structure legally and operationally.

Along a payment determinacy dimension, “Fixed Payment Amount” was chosen over “Variable Payment Amount”, for this example and the most likely first instrument, because it makes the instrument simpler to price, more comparable to other short-term instruments against which it will compete for investor dollars, easier to integrate with existing clearing and settlement infrastructure, and more tailored to satisfying regulatory expectations. Entitlement to the payments from entire claims bundle sold, on the other hand, which would be the case if the “Variable Payment Amount” were chosen, would require the buyer to use sophisticated methods to determine the expected actual payment on the claims.

This example need not correspond with the instrument that is issued first, or the instrument that comes to dominate the chosen marketplace for CBIs. Those instruments will be chosen from among the family with the most appropriate asset sold, and with the variable features from each dimension of variability that best meet the needs of the medical service providers, investors, regulators, and intermediaries.

The initial issuance will be a private placement, and so need not conform to the standards of any particular national market. It is intended only that the issue represent features that could, over time, be adopted as a valid instrument in a national, regulated market, where it would be cast most likely either as a debt instrument or as a special kind of asymmetric swap.

Using templates and parameters for product definitions enable the structuring of different variants within each member of the CBI family, accommodating different financial needs and regulatory requirements. Each of the example products is supported transparently by the processes and technology described herein with reference to HFX Business Service Components. This section also describes the way each product issuance can be transformed to best meet certain needs. For example, an initial issuance of a product by one party whose holder may use that product to support the issuance of different product. That is, CBIs are dissected showing their anatomy, and then showing how different CBIs and CBI parts can be reassembled for optimal utility, in different circumstances.

The processing steps and technology implementations for the Healthcare Funding X-Change described herein, generally apply to the entire CBI family. Each specialized CBI concept relates to the process steps necessary to manage the associated information about that type of CBI. This tieback is accomplished by showing where special steps must be included in or extended.

The products in the CBI family products are related to each other yet are different from each other, and how claims bundles underlie them all, and how the product types are governed by different sets of regulations.

A claims bundle instrument involves many parties, such as an originator, an issuer, an issue servicer, and a holder. A claims bundle instrument is defined by the rights and obligations of the parties that play roles with respect to the instrument.

Certain Obligations of a CBI Issuer Depend on the Underlying Contracts and Transaction Associated with the Claims.

Claims bundles may be fixed, containing a predefined set of claims, or fungible, meaning they contain claims meeting certain pre-defined characteristics, but that individual claims can be substituted for each other over time, as long as they have the given characteristics. The fungibility of the CBI is entirely separate from the fungibility of the claims in the claims bundle underlying the CBI. A CBI instrument subtype is fungible if, within certain bounds, its identity and value are independent of its issuer.

Certain features can be used with many CBI types, such as settlement perfected with a lien and the use of double lockboxes for payment.

Certain special legal rights and obligations of parties are described below for each of the four basic types of short term CBIs, based on fixed claims bundles. Products of one type may be used as the basis for products on another type, and how all the products can be perfected by similar placements of liens on the claims bundles.

Various means are described below for structuring a claims bundle instrument in a manner conducive for long term financing and fungibility between CBIs with different issuers and claims payers. This structuring will make use of the rules for any of the basic instrument types, and many of the variations within those instrument types.

The structuring of long term CBIs differs from that of short term CBIs, in that either fungible claims bundles underlie the CBIs, where claims in the bundle may be substituted after the bundle is formed, and where some of the payments on the claims might be held by the issuer in a sinking fund, or the instruments call for the substitution of entire claims bundles for each other.

These kinds of structuring enable the assets underlying the CBI to support long term debt. Each medical claim is typically fully paid within 90 days, and never more than a year, unless litigation is involved. Accordingly, medical claims are appropriate financial underpinnings for short term “money market” type financial instruments.

Tables 9 thru 13 present the features and attributes of instruments than may be set with optional values for any instrument type. Each type of claims bundle instrument is a different legal structure. However, across all or some of these different legal structures, the same business terms and conditions may obtain. For example, the amount paid to the holder of any claims bundle instrument can be a fixed or variable amount. The means for accomplishing this may vary from instrument type to instrument type. In addition, within each claims bundle instrument type, different kinds of terms could result in different kinds of financial instruments.

Most of these options would result in a different instrument subtype, each of which would require separate approvals, and trade separately.

### The CBI Family of Products

The nature of certain financial products based on medical claims bundles called Claims Bundle Instruments, or CBIs are described below.

CBI financial products are related to each other, and are based on medical claims bundles.

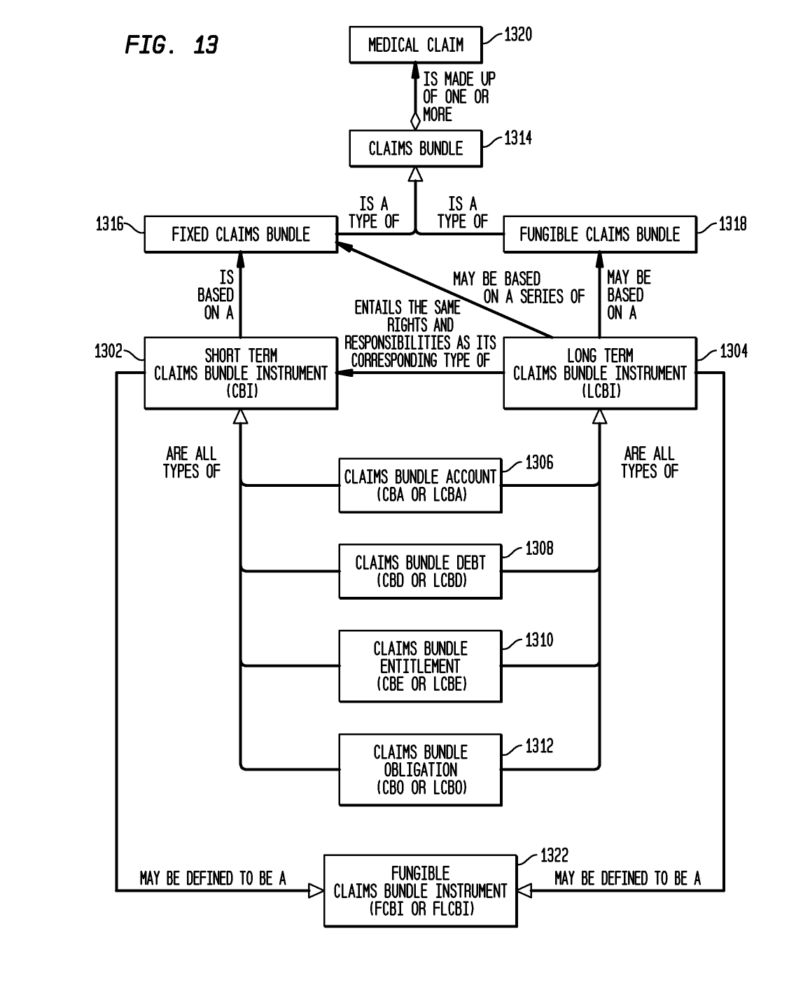

FIG. 13 Depicts an Example of these Relationships.

Claims bundle instruments (CBIs) come in two main families of types, a basic, or short-term CBI family 1302, and a long term LCBI 1304 family.

Both the CBI 1302 and the LCBI 1304 families have four instrument types; CBA 1306, CBD 1308, CBE 1310, and CBO 1312.

For the instruments in the long term family, the type name is preceded by an “L”.

All CBI 1302 and LCBI 1304 instruments are based, in different ways, on claims bundles 1314. The rights and obligations that define nature of this basis is what differentiate the four instrument types. The LCBI 1304 instruments have the same types as the CBIs 1302. CBIs 1302 are based on fixed claims bundles 1316, and LCBIs 1304 may be based either on fungible claims bundles 1318 or on a series of fixed claims bundles 1316. Each bundle in the series replaces the previous one, as it is completed.

Both fixed and fungible claims bundles 1316, 1318 are groups of medical claims 1320. Either a CBI 1302 or an LCBI 1304 may be fungible or non-fungible 1322. Fungible CBIs require additional attributes, and restrictions on attributes.

For the purposes of CBIs, a medical claim 1320 is a contingent asset of a medical goods or service provider, based on goods or services they have provided against a particular agreement, and which they have submitted to a payer for payment. This payer will often be an insurer. In this case, the agreement will be in-force insurance coverage.

When the medical claim is acknowledged as having been received and understood by the payer, it becomes a contingent liability of the payer. The payer then determine how much they are obligated to pay for the goods and/or services, which, in the case of insurance, will be conveyed to the provider as an “Explanation of Benefits” (or EOB). This is followed by actual payment for that EOB.

Each medical claim 1320 contains a number of line items, each for a different good or service providing occurrence. In current U.S. practice, line items are for specific procedures performed. As part of medical reforms, there is a possibility that in some case, this will change to claims for treatments of medical conditions, rather than for the procedures performed. These line items may be paid at different times and each with its own determination the obligation. The sum of the line item amounts is the net amount of the claim.

Thus, each medical claim 1320 is an account or subaccount of the provider, and correspondingly an account or subaccount of the payer.

A claims bundle 1314 is a group of medical claims 1320 that have been acknowledged by the payer. The sum of the net amounts of the claims 1314 in the bundle is the net amount of the bundle 1320. When these groups of claims are claims from the same provider, they represent an asset account of the provider, and when for the same payer, they represent a corresponding liability account of the payer. If multiple providers and/or payers are involved, then the bundle represents multiple accounts, accordingly. But in any case, the bundle is just a representation or identification of these accounts.

The attributes intrinsic to a claims bundle 1314 are all those derived from the attributes of the claims in the bundle. They are independent of the use of the bundle to underlie a financial instrument, and independent of a template specifying a type of claims bundle. These intrinsic attributes are presented in Table 5.

A claims bundle instrument 1302, 1304 is an agreement between the parties involved with claims bundles and other parties, with respect to rights and obligations that can be associated with the bundles.

The nature of this agreement varies with each of the four types of claims bundle instruments. In the simplest cases, there is exactly one instrument that can be sold for each claims bundle. In other cases, the instrument may be segmented into units, so that portions of the same issue can be held by multiple holders.

In illustrative embodiments of the invention, a single legal entity will play multiple roles. For example, in certain cases, a hospital might be both the originator and the issuer of a Claims Bundle Account. An insurance company might be both the payer and the issuer of a Claims Bundle Entitlement Multiple Servicer roles may be consolidated in a single entity, achieving considerable efficiencies. The CBI definitions simply require that each role be played by some entity.

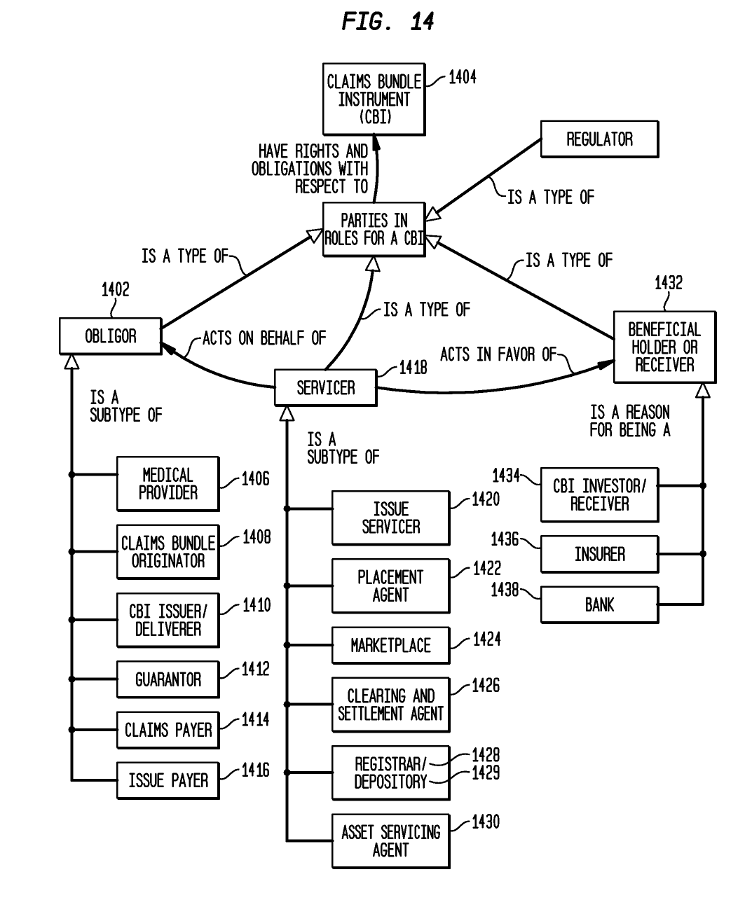

With reference to FIG. 14, there are four main types of roles played by parties. Within those types, there are several subtypes. The nature of the roles is the defining characteristics of the different CBI types. In almost all cases, there will be many fewer actual parties than roles, and in most cases, regulations will require than one party play certain multiple roles. For example, for a CBE regulated by the CFTC, the instrument issuer and the issue payer must be the same party.

It should be understood that the names of the roles, and their identification as distinct roles, varies from one regulatory venue to another. The names used are generic names that must be replaced with the appropriate words as defined by regulatory agencies and in different economic communities.

Most particularly, for CBEs and CBOs—those CBIs that may be cast as contracts rather than issued securities—the term “issuer” does not normally apply. Rather, both principal parties enter into a contract in which one party delivers, and the other party receives and pays for some item at a future date. Therefore, this model uses the term “issuer/deliverer” to designate either the party that issues the security or the party that delivers the claims bundle entitlements or obligations.

As another example, the term “registrar” is usually used to refer to a particular kind of legal entity associated with physical stock certificates. In this sense, registrars will be unnecessary for CBIs. But here, the term “registrar” refers only to the role of recording the current holder of a CBI position, a necessary function.

The definitions provided here are to be used to match with the official names of roles. Regulations define what types of legal entities are permitted to play which roles, and which roles must be played by different parties. Therefore, the HFX automated system assigns to each party, separately from the party identity itself, what roles the party is permitted to play, and uses business constraints on these roles to enforce these regulations. For example, if a regulator permits only financial institutions to issue financial instruments, then in that venue, it would not be possible to assign a hospital the role of “issuer. The roles provided here are as fine-grained as possible, so that it is even possible in different regulatory standards, two roles here may match with a single role in the standard.

The generic secondary market roles of buyer and seller are not explicitly identified in this model. They add no complexity or rules not already conveyed. And, in the case of contracts, there is no “primary” and “secondary” market distinction. Instead, if the contract is traded over the counter, the counterparties uniquely define the contract, which is a bilateral agreement between them, so the trade is conceptually always “primary”. If the contract is traded on an exchange, the exchange defines the instrument as a specific type of contract, and all trading is conceptually secondary to this.

Obligors 1402 are the parties who incur or may incur contractual obligations with respect to the claims bundle instrument 1404 itself.

When two obligor parties in roles are different legal entities, they must have explicit agreements with each other exchanging rights and obligations with respect to claims and claims bundles. When they are the same actual party, that same party need not have such explicit agreements with itself.

While the original focus of the CBI instruments is intended to be hospitals as medical providers and insurers as claims payers, there are many other pairs in healthcare where the same struggle over operating funds occurs: for example, laboratories and test clinics as medical providers and the medical device and drug companies for which these providers perform services, as claims payers. The CBI can provide lower cost financial support for these and similar pairs of parties as well as it can do so for hospitals and insurers, and each of these different pairs itself represents a large economic niche.

A medical provider 1406 is the party who provided the goods or services that are claimed by at least one of the individual claims in the claims bundle. The Medical provider 1406 must authorize that its claims be placed in a bundle. In some claims bundles, there may be multiple medical providers. But in the simplest claims bundles that will be initially in use, there will probably be only one.

Note that for simplicity of expression, in the initial explanations of the idea, the provider is not distinguished from the originator or the issuer, the roles explained below. Sometimes, even, the word “hospital” is used, instead of provider, since a hospital is the largest single source dollar volume of medical claims, so provides a good example. But in fact, providing medical services is always an entirely different role from the role that issues claims bundle instruments, and these roles will generally not be played by the same party.

A claims bundle originator 1408 authorizes, with agreement from the medical providers 1406, the assembly of a number of claims into a bundle. In the simplest case, the claims bundle originator 1408 will be a medical provider, who will also be the provider of all the claims. However, the claims bundle originator 1408 might be an insurer or other payer, who has constructed a bundle based on claims made by providers against that insurer, with the authorization of the providers. The bundle originator might also be a consortium of providers, who together produce bundles. The claims bundle originator is the party who must receive, from a claims communicator, such as a claims clearinghouse, the claims information for bundling.

An instrument issuer 1410 stands behind the issuance or delivery of some financial rights and obligations with respect to the claims bundle in question. In the case of an instrument with a prospectus, the issuer also defines the instrument. In the case of a contract, the definition of the instrument is created either by the counterparties (otc) or the exchange itself (exchange traded contracts). This is the instrument agreement, which might be embodied in a prospectus, and/or a purchase and sale agreement, etc., depending on the type of issue.

In order to issue a claims bundle instrument, therefore, the issuer 1410 must have obtained the rights to make further representations concerning the claims in the bundle, which must have been transferred from the providers via the originator. In the simplest case, an issuer 1410 could be the same party as the provider and the originator. However, for many instruments and regulatory venues, providers would not be permitted to be issuers, and even when they may be, there are several advantages, discussed later, of them not playing this role.

A guarantor 1412 guarantees the performance or a certain part of the performance of the issue according to the agreement behind the issue, in the case that one or more of the other obligors, as specified by the guarantor, fail to meet its obligations. It is envisioned that the Federal or a state government might serve as a guarantor of certain CBIs, such as CBIs where the claims payers are Medicare or Medicaid.

A claims payer 1414 is responsible for paying at least one or all of the claims in the claims bundle in question. There may be more than one claims payer per issue, although in the simplest case there will be only one.

An issue payer 1416 is responsible for making the payments to holders or receivers of the issue or contract. This may be the same party as the one claims payer for an issue, or it may be a different party. However, if it is a different party, then it must have acquired the right to receive and redirect the payments from the claims payer(s).

A servicer 1418 is a party who has a contractual agreement with various principal parties, obligors and/or holders, to act on their behalf, ensuring to these principal parties that their obligations are met and their rights exercised, or providing them with a means of enjoying those rights.

An issue servicer 1420 is a party who, on behalf of the issuer, tracks the information about the issue, conveys instructions to other agents about the issue, such as instructions to paying agents, or carries out those instructions itself. In some cases, the issue servicer 1420 may be the same party as the issuer.

A placement agent 1422 is a party who, on behalf of the issuer, finds a buyer (who then becomes a holder) of the issued instrument. The placement agent 1422 may be the same party as the issuer, it may be a role played by an exchange, or it may be a role combined with other roles, such as the role, for certain types of instruments, of an underwriter who guarantees placement, or a special purpose entity that is the first buyer of the issue, with the intent of reselling the issue to other buyers. It is anticipated that the first issuance of a CBI will be sold via a private placement, in which the placement agent locates candidate buyers and selects one of these.

A marketplace 1424 is a venue in which the CBI issue is exposed to a number of potential buyers, who can bid on the issue or a part of the issue with the issuer or its agent, and if they choose to sell.

An exchange is a marketplace provided by a party that follows trading rules supporting market transparency, and may include all or many of the servicer roles for the CBIs in this single party. HFX provides the pattern for the marketplace, clearing and settlement, registrar/depository and Asset Servicer roles to all be played by the same party for most CBIs. Exchanges will also, in conjunction with regulators, define the instrument types that may be traded on the exchange.

A Clearing and Settlement Agent 1426 enables the CBI trades made by the buyers and sellers to clear and settle: that is, to determine that the buyer and seller agree on their mutual obligations to each other as expressed in the trade, and then to bring about the consequent exchange of money and CBI positions. The clearing and settlement agent 1426 also assumes some or all of the settlement risks for the settling parties.

The Registrar 1428 is the role of recording the actual holders of CBI issues or units of CBI issues. For electronic issues recorded centrally, the term “registrar” is not used, since, as previously described, there is no need for a separate legal entity to perform the function. The depository 1429 holds CBIs or the claims bundles underlying the CBIs in trust for the actual holders. These roles work in consort with clearing and settlement agent(s) 1426.

An Asset Servicing Agent 1430 acts on behalf of the holder of a CBI to ensure that it's right as a holder are exercised. The asset servicer 1430 tracks the CBI positions of the holder, collects the payments received from the CBI, and reconciles these with the payments due. Beneficial Holders or receivers 1432 are the parties who have the rights accruing from having purchased a CBI. In most cases, these rights include the right to re-sell the CBI to another party, or in the case of contracts, either to buy out the contract at its current value, or to enter into offsetting contracts as a deliverer.

The term “beneficial” separates this role from the role of a registry/depository who may hold the CBI on behalf of the beneficial holder. In reality, there may be several levels of holders, each holding on behalf of some other entity, but in terms of the direct right to buy and sell, and directly receive the benefits, only the first entity in this chain is known to the marketplace and the registrar/depository.

While there is only a single beneficial holder role, there are different parties in the financial community who might wish to hold CBIs for various reasons. There are additional reasons for buying and selling long term LCBIs that are not discussed here.

The reasons for holding short term CBIs, include, but are not limited to an investor/receiver 1434, an insurer 1436 and a bank 1438. An investor 1434 holds a CBI in order to maximize return and minimize risk on money that the investor will need to use in a relatively short period of time. An insurer 1436 may hold a CBI in order to obtain a matched book with its contingent liabilities, for which it would otherwise need to carry a cash reserve. A bank 1438 may hold a CBI as a lower risk, lower cost means of extending cash to health care providers than is afforded by balance sheet based loans.

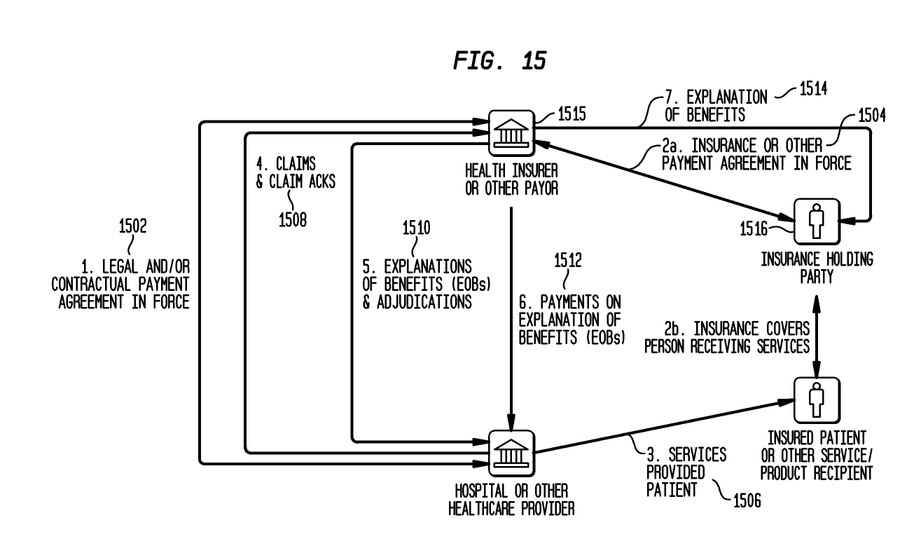

The preconditions for claims bundles to underlie securities of any kind are described generally with reference to FIG. 15. Such preconditions depend on the contracts and transactions associated with the separate claims that may be in the bundle.

The validity of Claims Bundle Instruments as a particular form of instrument depends on the certification by the issuer of the appropriate preconditions for the issuance, and the issuer's responsibility for the truth of this certification; the ability of the holder or a representative of holders such as a regulator body, to validate those preconditions; and the issuer's responsibility for ensuring that the holder of the issue receives the benefits of holding the asset sold by the issuer and every subsequent seller.

While these are responsibilities of the issuer of the instrument, they depend on the actions of the service provider who makes the original claim. So, the issuer, whether the same entity as or a different entity from the service provider or bundle originator, must ensure that the contractual underpinnings exist and that the business transactions related to each claim in the bundle occur.

The issuer of a Claims Bundle Instrument may or may not be the same as the service provider making some or all of the claims in the bundle. The actual issuer may be some other trust institution acting on behalf of the service provider(s), perhaps with the further intermediation of a bundle originator.

This will depend on the regulations governing the instrument. For example, a hospital may be permitted under the UCC to be the issuer of a Claims Bundle Debt as asset backed commercial paper, using its trust institution as an agent, but would probably not be permitted to issue a Claims Bundle Entitlement as a future, where the trust institution, would itself be the issuer, in a relationship with the provider(s) and/or originator whose claims were represented in the issue. (The nature of this relationship is discussed in the section on CBEs.) These underpinnings and transactions are organized as associations between parties according to: the contracts and implicit contracts and legal conditions that must exist before issuance; the transactions that must have occurred between parties before issuance; and the issuer's responsibilities for transactions that will occur after issuance. Each of these types of associations is depicted in FIG. 15.

An In-Force Agreement With Payer 1502 includes an obligation to certify that the claim is against a predefined obligation of the payer to pay for medical services of this general kind. For example, Mechanisms for Verification include the use of the standard provider procedures in the identification of the payer. For example, the use of identification codes for an in-network HMO Mechanisms for verification also includes the acknowledgement of the receipt of the recognized claim by the payer. For example, the receipt by the provider's claims clearinghouse of the claim acknowledgement from an insurance company.

An In-Force Insurance Between Payer and Service Recipient 1504 includes an obligation to certify that the claim is against a predefined obligation of the payer to pay for covered medical services for this service recipient (ordinarily a patient). Example: a patient is a member of the given HMO. The insured party may not be the same as the service recipient, when the service recipient bears a relationship to the insured party that causes the recipient to be covered by the same insurance.

Services or Goods Provided 1506 include an obligation to certify that the health care services or goods have actually been provided to the recipient (ordinarily patient), and that the recipient has authorized their provision.

Mechanisms for Verification include the existence of records to show that the patient or power of attorney for the patient has authorized the products and services to be provided and the use of the standard provider or sub-provider procedures in the establishment of services delivery. For example, the existences of a completed and signed treatment form.

An Acknowledged Claim against the Payer 1508 includes an obligation to certify that the claim has been acknowledged by the payer as having been received and in conformance with In-Force Agreements with Payer 1502 and In-Force Insurance between Payor and Service Recipient 1504.

Mechanisms for Verification include the existence of the appropriate records to establish that the claims can be made. For example, if pre-approval is required from the payer, the existence of the records that show that pre-approval has been obtained. If referral is required, the existence of the records that shows that a referral has been made. Other Mechanisms for Verification include the use of the standard provider procedures in the establishment of the fees in the claim. For example, if there are negotiated fees for the given service with the given provider, the use of the negotiated fee table to determine the net amount of each such line item in the claim. Another Mechanism for Verification includes the acknowledgement of the receipt of the recognized claim by the payer. For example, the receipt by the provider's claims as claim acknowledgements from an insurance company.

Explanations of Benefits and Their Adjudication 1510 include an obligation to ensure that explanations of benefits are compared against claims and to ensure that adjudication of benefits is pursued if this will lead to better instrument performance for the holder.

Mechanisms for Execution include the receipt of explanations of benefits by the appropriate agent of the provider, for example, from the insurer to the provider's claims clearinghouse, and the use of a standard procedure for adjudicating differences in benefits. Payments on Explanations of Benefits 1512 include an obligation to ensure that the payments stipulated in the CBE are made to the holder of the CBE, and that no claim can be made with respect to these payments as assets of the provider.

Mechanisms for Execution include an agent of the issuer informing the instrument purchaser that the receivables have been assigned to the purchaser as holder and informing the payer that the receivables are assigned to the holder, except in the case of Medicare and Medicaid, where a financial statement against the issuer is filed with the Secretary of State of the state of domicile of the issuer. Another Mechanism for execution includes the issuance of the appropriate instructions by an agent of the issuer to the paying agent to redirect payments from the provider who receives the payments, so that the payments are directed to the holder. For example, the provider will issue standing instructions to its paying agent to accept instructions from the HFX asset servicing agent to redirect payments from an incoming escrow lockbox to a lockbox for the holder.

Insured Copies of Explanations of Benefits 1514 are provided a Health Insurer or other payor 1515 to an Insurance Holding Party 1516.

Claims bundles on which the various CBIs may be based may be fixed or fungible.

A fixed claims bundle includes a claims bundle, the claims contained in which are identified when the claims bundle is issued, and which never change, as these claims are settled.

A fungible claims bundle includes a claims bundle, the claims contained in which, are specified according to some of their attributes, when the claims bundle is issued, which, at any point in time, will be populated with a set of claims that fulfill that specification, but in which the individual claims may change, as long as the specification of attributes is met.

The specification may describe a bundle that increases or decreases in size over time, so that the size of a single fungible claims bundle can vary over time, if that is what the specification calls for.

Thus, a fungible claims bundle is characterized by a specification of the following kind: time period 1, claims with attributes A1, 1, in net amount A11, claims with attributes A12, etc., for as many attribute set net amount pairs as desired for time 1.

Time period 2, claims with attributes A2, 1, in net amount A2 1, claims with attributes A22, etc., for as many attribute set net amount pairs as desired for time 2 etc., for as many time period N, attribute set, net amount sequences as desired.

A time period is specified by a start date and an end date. Normally, a fungible claims bundle will only contain a single time period, and in most cases, only a single attribute set, net amount pair. For example, the claims bundle specification might stipulate that the bundle shall exist between Oct. 1, 2009 and Sep. 30, 2011, that all claims in the bundle must be from in not-for-profit hospitals in the state of Massachusetts and be claims against Massachusetts Medicaid, and that the total net amount of claims in the bundle must be at least $11,900,000. In this simplest common case, new claims can be substituted for claims in the bundle as long as they have the attributes desired.

The fungibility of claims bundles and claims bundle instruments are completely independent features. The fact that a claims bundle is fungible does not mean that the CBI it underlies is also fungible. And, the fact that a CBI is fungible does not imply that the claims bundle underlying it is fungible.

For each type of CBI, the rights of the holder include the obligations of the Issuer to perform as required, and to enforce that the providers and bundle originators perform, to insure total compliance of each obligor to meet representations and warranties made to the current holder.

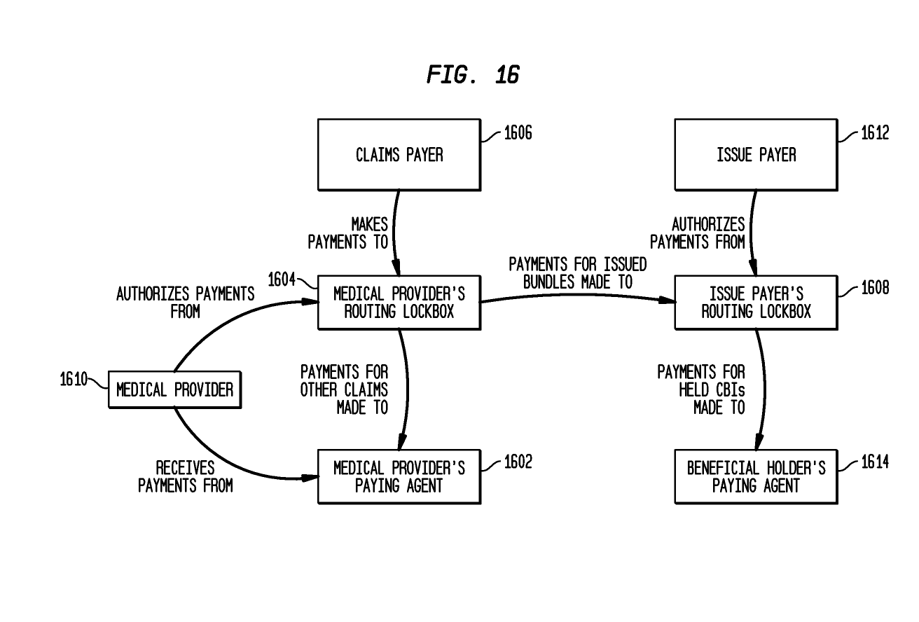

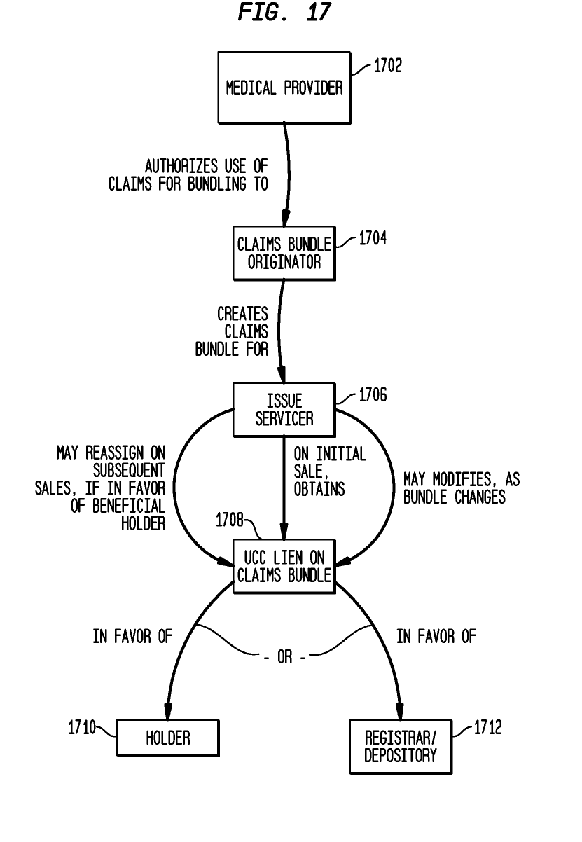

In order to comply with the “non-assignment” rules of Medicare and Medicaid, a CBI with underlying bundles containing either Medicare or Medicaid claims will require a double lockbox mechanism for each provider submitting claims in a bundle. These so called “non-assignment” rules are not, in fact, non-assignment rules. They are rules that state that all Medicare and Medicaid (in most states) payments must be made to the provider who made the claim. That is, they make no restriction on whether the provider assigns the claim, only that the payment must be sent to an account in the provider's name. As illustrated in FIG. 16, in this mechanism, a paying agent 1602 is given certain control over the provider's first lockbox 1604. Payments from claims payers 1606 (typically insurers) into a first lockbox 1604, can then be directed for those claims in a sold CBI bundle to a lockbox 1608 under the control of the issuer, administered by the issue servicer. The provider 1610 must supply his paying agent 1602 with instructions to accept instructions about such redirection from the issue servicer 1612. This second lockbox 1608 might be a single lockbox, from which the issuer servicer 1612 again redirects payments to the holders 1614. It might also be a separate one for each holder, but the first mechanism is likely the more efficient.

In general, it is extremely likely that Medicare and Medicaid bundles will contain claims only against Medicare payers or Medicaid payers. But since about half of medical payments from Medicare or Medicaid are for hospitals, it might be most efficient for this double lockbox mechanism to be used in all cases, even for private insurers, where it may not necessary.

However, the sweeping mechanism for the provider's first lockbox that redirects the appropriate payments to the issuer payer's routing lockbox may be turned off in case of bankruptcy, or merely by an instruction from the provider to the issuer's paying agent. As a result, additional measures to protect this flow are desirable.

Generally all CBIs, except for Claims Bundle Obligations, may be “perfected” by the placement of a lien on the claims bundle. The interest of the CBI holder, or a designated intermediary of the holder, is secured via a UCC lien or modification thereof, placed with the respective secretary of state of the provider(s) of the claims in the bundle.

Perfection helps ensure non-recourse from the creditors of the providers making the claims in the bundle, in case of provider bankruptcy, and supports the effective transfer of claims bundles to the holders, even in cases where the claims are legally non-assignable as part of the instrument definition or for other reasons.

Perfection is defined and warranted as part of the issue, by the issuer; its execution is a function of completing clearance and settlement.

While most CBIs will be perfected, since this will greatly increase the safety of the instrument, it is possible that for certain reasons, some issuers or contract exchanges would choose to issue non-perfected CBIs. For example, for the CBA, which is the true sale of the bundles in the accounts, perfection might be deemed inappropriate, since it may not be possible for an entity to take a lien in favor of itself, on property owned by the entity itself, and doing so may even call into question its ownership. On the other hand, the fact that Medicare and Medicaid claims may be sold, but the payments must still be made to the provider's account might make the existence of a lien desirable.

For another example, if a contract exchange chooses to support a CBE contract using a Healthcare Funding Trust, arrangement liens in favor of the CBE receiving counterparty, might be inappropriate. However, for the delivering party to provide a lien on a CBA to the clearing and settlement role of the exchange might be effective.

The manner in which the lien is placed and modified will depend on the properties of the CBI. For example, if the payment on CBI is a fixed amount, then the lien is released when that fixed amount has been paid. If the payment on the CBI is variable, and depends on the amount of the claims that is ultimately paid by the payors, then the lien is released when all claims have been paid or otherwise settled.

Other ways in which the lien process may vary are described with reference to FIG. 17. The parties in whose favor the lien is placed depend on the issuance and clearance and settlement processes, and so also may vary within the same type of CBI. For example, the lien may be placed only once at the primary market sale, to a registrar/repository entity. Lien modifications typically are required in the cases where the payments on the CBE are made over time, thus reducing the amount requiring the maintenance of the lien.

In the illustrative embodiment, a medical provider 1702 authorizes use of claims bundling to a claims bundle originator 1704. the claims bundle originator 1704 creates claims bundles for an issue servicer 1706. the issue servicer 1706 may obtain a UCC Lien 1708 on the claims bundle. The issue servicer 1706 may also modify the UCC Lien 1708 as the bundle changes or may re-assign the UCC Lien 1708 on subsequent sales if they are in favor of the beneficial holder. The UCC Lien 1708 may be in favor of the beneficial holder 1710 or the Registrar/Depository.

In the embodiment described with reference to FIG. 17, the Issue servicer 1706 is acting on behalf of the issuer, and the claims bundle originator 1708 is acting on behalf of the medical providers.

Several key elements in enabling the widespread use of CBIs include: the insulation of medical providers from new financial and legal complexities; the easy access to issuance for any medical provider; the provision of a large volume of standardized instruments; the availability of the instrument to a large body of investors; and the minimization of risks and costs associated with clearing, settlement, and holding of the CBI.

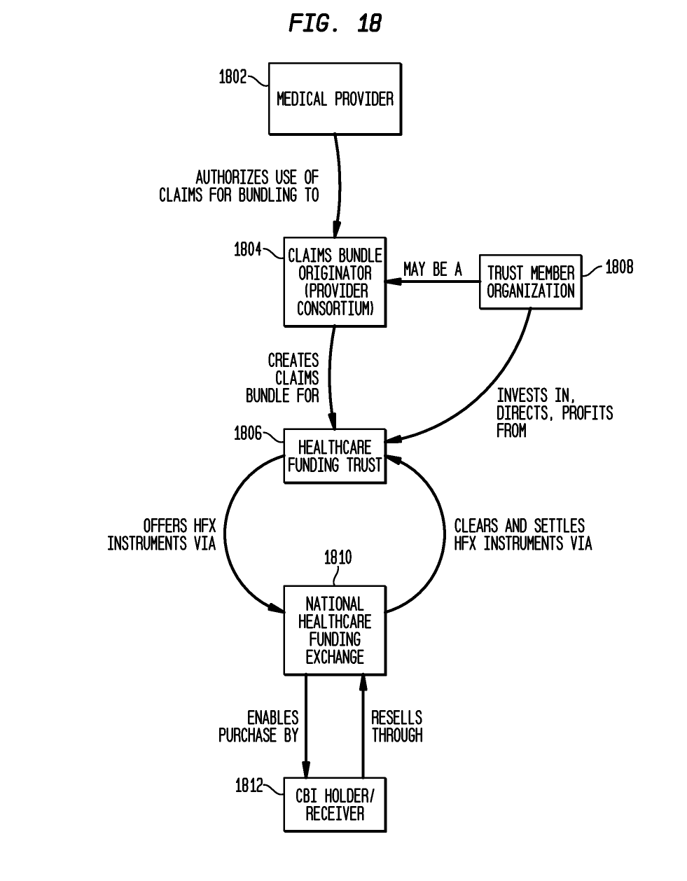

An embodiment in which an institutional focus is required is described with reference to FIG. 18. This institution: provides the initial capital for transforming claims bundles into claims bundle instruments; provides a central, trusted registry, depository and clearing function for the instruments; and reaps some of the rewards of the savings on medical costs effected by CBIs In the illustrative embodiment, a medical provider 1802 authorizes use of claims bundling to a claims bundle originator 1804. The claims bundle originator 1804 creates a claims bundle for a healthcare funding trust 1806. A trust member organization 1808 which may also be a claims bundle originator 1804 invests in direct and profits from the healthcare funding thrust 1806. The healthcare funding trust 1806 offers HFX instruments via a National Healthcare Funding Exchange 1810. The National Healthcare Funding Exchange 1810 clears and settles HFX instruments via the Healthcare Funding Exchange Trust 1806. The National Healthcare Funding Exchange enables purchases by a CBI Holder/Receiver 1812. The CBI Holder/Receiver 1812 resells through the National Healthcare Funding Exchange 1810.

A case in which the existence of a funding trust is essential for a CBI is for the Claims Bundle Entitlement, if this instrument is construed as a swap contract. In this case, because the buyer must make payments upfront, the assurance of risk free settlement is best accomplished by managing the assets by domiciling them in a special purpose trust.

A suitable sponsor for the Healthcare Funding Trust is the federal government, via, for example, a Government Sponsored Entity. Sponsoring by the federal government will help enable: that CBIs and other healthcare funding instruments are structured to deliver benefits to the public and that the savings from the use of CBIs can be channeled to the benefit of the public. Sponsoring by the Federal Government will also assure that the use of CBIs grows rapidly enough to immediately effect health care costs.

Independent of the creation of a government sponsored entity enough good reasons exist to construct a healthcare funding trust, initially, sponsored by a consortium of health care providers, insurers, and financial entities.

Just as each type of CBI is based on its underlying claims bundle, so too is the valuation of any CBI based on the valuation of the claims in the claims bundle. The valuation of the particular instrument will depend on pricing algorithms derived from the instrument definition, together with this consistent underlying value.

The mechanisms for providing the valuation of the claims bundles are not a subject of this patent, but they are well understood. The payment amounts and timing of payments for individual claims is effectively predicted by many insurance companies, for their own claims; the payments and timings of claims made is carefully tracked by many health care providers, especially hospitals. There also exists well-tested third party software for accurately predicting payments and timing of payments on claims.

CBIs provide a more predictable, pre-defined, marketable instrument, which can be exposed to a national marketplace, in place of the bilateral private funding arrangements that predominately are used by health care providers today.

However, there are several ways in which the use of one of the CBI types as a vehicle for transmitting the bundle from a provider to a trust institution can provide a foundation for the trust institution to issue a different type of CBI. These are called CBI Transformations. For example, a Healthcare Funding Trust could be a repository of CBAs issued by health care providers that were the basis for CBEs issued by the trust. The variety of these many-to-one issuances and their subsequent transformation for the multi-lateral use of the instruments is described below.

The CBA asset sold by the issuer is the asset accounts that represent the claims that have been filed by the providers. Initially, the account is held by the providers making the claims in the bundle, so the claims must be transferred from these providers to the buyer. Thus, when a claims bundle contains claims from multiple providers, the sale of the claims bundle involves multiple account sales, one for each provider.

In order to accommodate fixed payment CBAs, a CBA from a single provider may also include a repurchase agreement, such that after a certain amount of the claims in the bundle have been paid, the claims bundle is repurchased by the provider for a pre-determined amount. A single provider bundle may be created first with this feature, and then aggregated into multiple provider bundles.

The issuer of a CBA will usually be the same as the claims bundle originator, the entity that is responsible for assembling the claims bundle, and will be a medical provider or a set of medical providers. For example, a single hospital might issue CBAs for itself and its associated entities, such as its medical practices and laboratories. The issuer's responsibility for the validity of the claims in the bundle is assured by a repurchase agreement in case this proves not to be the case.

The issuer may be a larger medical entity, or consortium of medical providers formed specifically to issue CBAs.

This set of providers can be supported in issuance by an authorized issue servicer, who operates the technology for assembling the bundle, as well as acting as issue payer. The CBI concept as applied to the CBA, enables medical providers to participate transparently to their current business activities. This is accomplished, for a CBA, by a consolidated issuer's agent entity that serves all the issuance needs of the medical provider.

If the CBA is sold to a beneficial holder via a private placement, then the issue servicer and the placement agent will likely be the same entity, which could be a trust company or an investment bank.

The CBA might be made available for sale, through an extension of its capabilities, via an entity such as the Receivables Exchange™ instead of via private placement,. On such exchanges, the clearing and settlement is still a separate, bilateral activity, so the issuer would require support from the issuer's agent for this purpose as well, making a trust company an especially suitable agent. Alternatively, the issuer's agent could be the insurer whose claims are represented in the bundle.

Many investors interested in commercial paper or other money market instruments could find interest in CBAs. This would probably not include money market funds, since the CBA itself would probably not quality as a money market instrument.

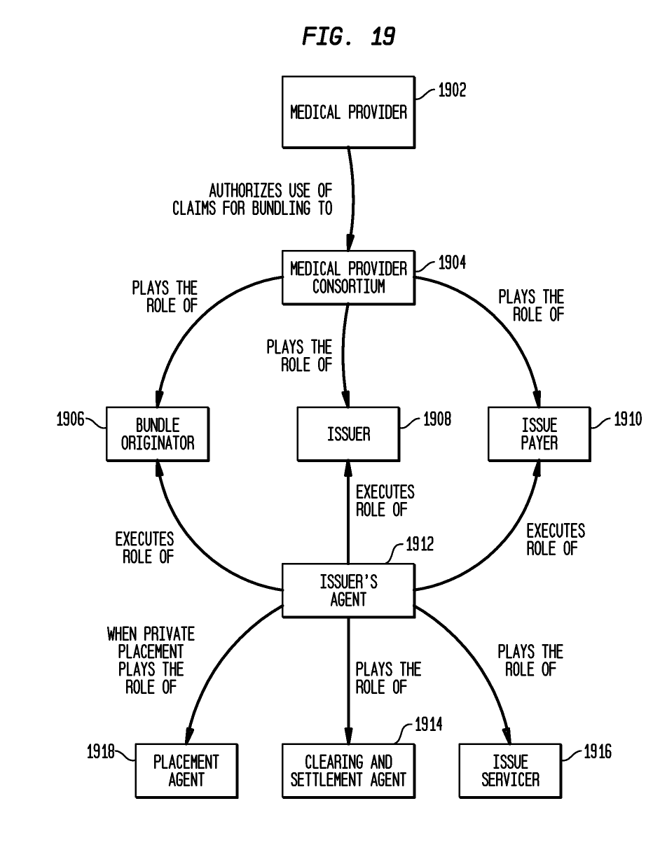

Typical keynotes of parties involved with a CBA according to an illustrative embodiment of the invention are described with reference to FIG. 19. A medical provider 1902 authorizes use of claims for bundling to a medical provider consortium 1904. The medical provider consortium 1904 may play the role of a bundle originator 1906, and, if authorized, an issuer 1908 and/or an issue payer 1910. An issuer's agent 1912 executes the role of bundle originator 1906, issuer 1908 and/or issue payer 1910. The issuer's agent 1912 plays the role of clearing and settlement agent 1914 and/or issue servicer 1916. The issuer's agent 1912 may also play the role of placement agent 1918 when a private placement is involved.

By selling their accounts as part of the claims bundle, the claims are removed from books of the providers as a (perhaps contingent) account receivable, and replaced by cash, improving their balance sheets. This cash is available to the providers immediately, at very little cost, compared with loans made by banks against the providers' balance sheets or compared with the cost paid to factors for the sale of accounts, especially if a fixed payment amount CBA is used. The issuance and sale of a CBA transfers the risk of receiving payment to the holder depending on the responsibility of the providers, the claims payers (usually insurance companies, and sometimes the federal or state governments) to meet their current claims obligations. This ability is usually backed by agreements and legally required reserves or in some cases special funds, such as the Medicare fund.

The sale of accounts is a special kind of Asset Sale, governed by the Uniform Commercial Code and state laws. In current practice, the purchasers of accounts receivables are factors, and each claim is purchased is a separate transaction. The CBA is an extension of this practice, in that the accounts are sold in a bundle and the accounts may, before the sale, belong to different providers. Also, for a fixed amount CBA, there will be a return agreement in effect so that the accounts are returned to the issuer after a fixed amount has been paid against the bundle. This return agreement contrasts with factoring, in which the account becomes the permanent property of the factor, and the factor repays a percentage of any amount over the purchase price that is paid on the account, back to the seller.

The purchase and sale agreement for a CBA can stipulate the sale in three ways simultaneously. The sale can be stipulated as a UCC transfer of assets, as a transfer of an interest or claim under an insurance policy, and finally, provisionally, in case the sale were recast as a financing by a bankruptcy court, and a grant of the receivables as a security interest to the purchaser.

The holder must be informed of the assignment and/or lien, and in order for CBAs to be protected against the obligations of the providers. In some states, the claims payers must also be informed of the new holders of the claims bundle. The simplest case is to treat all CBAs the same in this respect.

The CBE asset conveyed by the issuer is the entitlement to the receipts of some or all of the proceeds of payments made for a claims bundle. In the CBE, the claims bundle account itself is not sold. Rather, only an entitlement to receipts is sold. The entitlement is expressed as a contract for future delivery of money from the bundle.

This entitlement is transferred to the holder via an executed purchase agreement from the existing holder (including an issuer) to the new holder. As a result, the claims in the bundle remain owned by whatever party owned them before the issuance of the CBE. So, any issuer of a CBE must be either the owner of the claims in the bundle or the purchaser of one or more CBEs from a designated issuer, repackaged for reissue. Depending on the particular type of CBE, the future delivery may be guaranteed or not, it may be for a fixed or variable amount, the delivery times can be fixed or variable, the exchange of monies by the counterparties may be at the same time or different times, but it has a final delivery date.

The issuer of a CBE is generally either; an entity who filed the claims for services provided or its designated agent, where that entity is still the holder of the claims bundle; an entity that has purchased the claims individually, or its designated agent, an entity or its designated agent that has purchased CBEs and repackaged them; or an entity or its designated agent that has purchased the claims bundle as a CBA, or has purchased a number of such CBAs rebundled and used this bundle as a basis for the CBE.

The latter entity is generally the most desirable and likely of these issuers, for the following reasons.

First, the value of the CBE will most fully be realized when the CBE is issued, and perhaps made fungible, retraded, and related to long term fungible CBEs, on a national market. Second, the value of the CBE is greater when it is insulated from exposure to the creditworthiness of the medical provider. This will occur when the medical provider has sold the claims or has sold a claims bundle.

Therefore, the likely issuers of CBE are trust or other financial institutions, who, in the general case, will have purchased CBAs or for the first few issues, might have purchased the original claims from the provider(s) with a repurchase agreement.

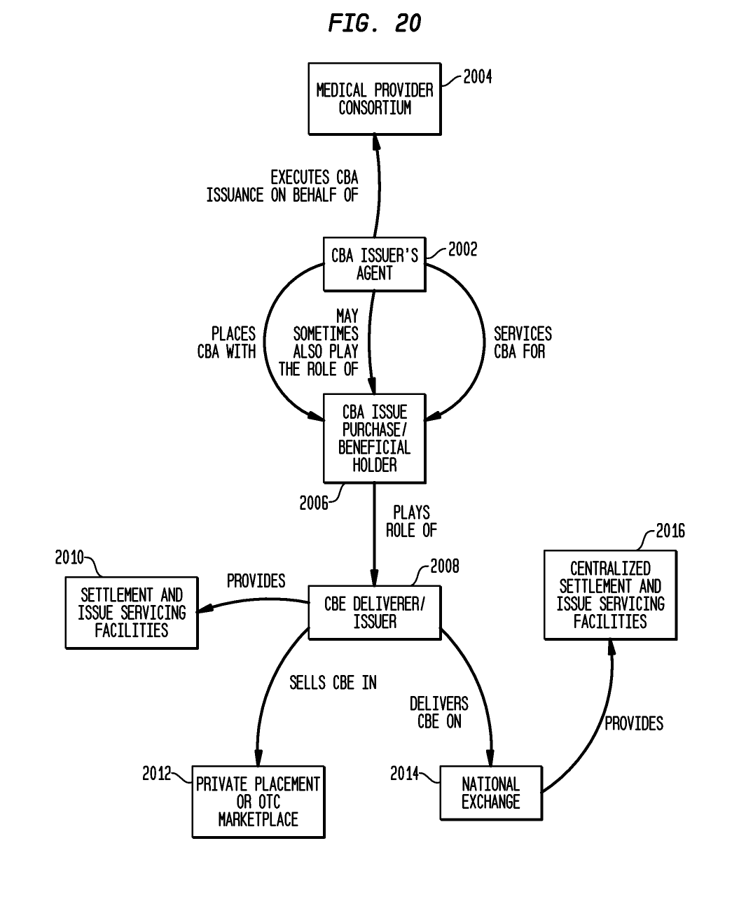

Typical key roles of parties involved in CBE according to an illustrative embodiment of the invention are described with reference to FIG. 20. A CBA issuer's agent 2002 executes a CBA on behalf of a medical provider's consortium 2004. For medical providers, the issuance of the CBE by a trust institution is a vehicle by which the medical provider can sell its claims receivables in a CBA to such institutions at effective rates commensurate with the very low risk in the CBA. These rates are considerably lower than bank loans, let alone factored receivables.

From the point of view of the issuing trust institution, the issuance of a CBE based on a purchased CBA enables the institution to effectuate a credit enhancement function with very minimal risks. The insurers themselves, as well as some hospitals and some rating agencies and other risk analysis purveyors, possess highly accurate, well back-tested tools that enable the prediction of the minimum claims amounts that will be actually be paid via a claims bundle, as well as the other relevant values, such as the minimum that would be paid within 90 days. The use of these tools and the type of data required by investors in the HFX marketplace is described before herein.

For regulatory purposes a CBE could be cast as a special kind of asset sale, or as a debt, in which case it would be subject to the same regulations and trading venues as a CBA or a CBP. A CBE can be treated as a contract rather than an issued security in various ways.

In order to serve a most fundamental purpose of the CBI, payment for the delivery of a CBE is made up front. Such a contract requires no additional payment by the holder on delivery date. This is different from the common practices in this industry because there need be no margin maintained by the CBE receiving party, and either the claims bundle, or a CBA instrument, are held in trust for the contract to trade on an exchange.

This requires that the CBE to qualify as a swap or some other new derivative on the Intercontinental Exchange which would require CFTC approval of the new instrument. These CBE contracts are issued with one or more standard final settlement dates, for example, Early September and Mid September. The CBE contracts are fungible among a class of claims payers, for example, AAA rated health insurers, so that they might be sold as AAA Mid-September $1,000,000 CBE contracts.

In order for the CBE swap contract to be useful for monetizing the claims bundle, however, extends the notion of a swap, in much the same was as does the Credit Default Swap, to include payments to the counterparties occurring at different times. The party on the claims bundle payments delivery leg of the swap receives its money at the beginning of the swap, while the party who received the claims bundle entitlement receives its money either as it is generated by claims payments or at the end of the swap. A more standard derivatives contract is possible, but may not serve the economic need.

On the other hand, rather than simply being an issuer's agent for North Shore-LIJ Claims Bundle Accounts, a bank may take on another role and buy the CBAs and then issuing the AAA Mid-September $1,000,0000 CBE Contracts on ICE itself. In this case, a health care provider consortium could be the purchaser of some or all of these contracts. In the interest of insuring transparency, a consortium of health care providers, insurers, and an exchange such as ICE could together create a special purpose vehicle for CBAs and CBEs, similar to the role ICE Trust serves for Credit Default Swaps. In this example, such a “Healthcare Funding Trust” (HFT) is the purchaser of all CBAs from hospitals and the simultaneous issuer of CBEs based on the CBAs.

A CBE can be cast as a forward contract for the future delivery of the money to be derived from the claims bundle. But, unless the CBE delivering counterparty (i.e., the issuer/deliverer) is paid at the opening of the contract and the receiver of the Claims Bundle Entitlement is paid at the end, the contract may not serve the intended economic purpose.

A different, and more standard forward, called a “symmetric CBE forward,” in which the variable amount paid from the claims bundle was received by the entitled party, while at the same time, the delivering party received the fixed forward price of the contract, is possible, and especially for longer term contracts, this could have its own, different, economic purpose, of transforming the variable amount actually paid by the claims payors for a claims bundle into a fixed amount, at some small cost, given the accuracy with which the amount to be paid for claims bundles can be predicted using appropriate software. It would then be relatively easy to recast such a symmetric CBE forward into a future, but again, such a future would not serve the primary economic purpose of CBIs. This instrument is called an Asymmetric CBE Forward. When cast as an asymmetric swap, a CBE can be traded on a contracts exchange, in which the CBE delivering party delivered a CBE to the exchange in some form, either as a lien on a claims bundle or as a CBA to be held in trust. The receiving party pays for the CBE at initiation of the swap, and receives the claims bundle payments either contractually, or as produced by the bundle either in a fixed or variable amount depending on which of these proves most desirable on analysis and test marketing.

Since at time of writing a swap contract, it has a zero value, it is unusual for one party to be paying immediately. However, the party is not paying for the contract, but rather making payments on one leg of the contract.

In an illustrative embodiment of the invention, there are four variants of the CBE, in terms of the fixity of payments that might make the CBE more or less acceptable as a regulated future. These are shown in Table 6.

A CBE with actual payment timing and variable payment determinacy is, in effect, a pass-through instrument, like a mortgage pass-through. The other forms of CBEs and all other CBIs are not pass-throughs. There are special rules that make the relationship between the claims payments on the bundle and the payments on the instrument not direct, and usually more economically useful to the issuer and holder. A list of CBE subtypes, by payment types is illustrated in Table 7.

The fungibility of CBEs depends on fixing certain of the parameter values in a CBE template. These parameters include the claims payer risk class and the final delivery date. Claims Payer Risk Types are combinable into Claims Payer Risk Classes where example of Claims Payer Risk types are private insurer of a given risk category, Medicare payer, Medicaid payer by state. With all the claims payers in the same claims payer risk class, fungibility is achieved and enables the claims of multiple payers to be bundled together underlying a single CBE issue. There may be economic or risk-related reasons why a single payer may opt to purchase a CBE based on only its own claims obligations.

The Final Delivery Date must be a pre-defined date (or dates) each month or week. The requirement for fixed delivery dates, combined with the economic need for claims bundles to be packaged and funded at least weekly, if not daily, would require a weekly metric for delivery dates, or else an intermediary role to smooth the differences between claims dates in the bundles and the delivery dates of the contracts. A weekly set final delivery date would make the CBE most like the US Treasury Bill.

A Claims Bundle Pledge (CBP) differs from the CBA in that with the CBP, the issuer continues to be the owner of the claims bundle. While in a CBA, the buyer takes possession of the bundle. The asset conveyed by the issuer is the obligation of the issuer to pay given amounts to the holder at certain time(s) in the future, with the claims bundle entailed as collateral against that payment. The debt of the issuer is the asset that is conveyed, not the claims bundle itself. Instead, the claims bundle is pledged and will be conveyed to ownership of the holder of the CBP in case the debt is not paid.

The CBP differs from the CBE, in that in the CBE, the delivering party is neither borrowing from the buyer, nor selling the claims bundle to the receiver. Rather the deliverer is transferring to the buyer guaranteed rights over of the CBE payments to the receiver.

A CBP must either be based on a fungible claims bundle, in which paid claims are replaced with unpaid claims over the duration of the debt, or else must include a sinking fund associated with the bundle, where the funds paid on the bundle are held as part of the pledge until the debt is paid off.

A non-fungible CBP is asset-backed commercial paper, (ABCP) which is a short term debt instrument from the holder of the asset—the claims bundle to the buyer.

A CBP differs from typical ABCP in that the assets for the CBP are highly liquid and, if the claims bundle size is properly calibrated to the debt, are not subject to the economic variability of the value of consumer debt or fixed assets.

In addition, the payment on the CBP is not subject to the creditworthiness of the issuer. Rather it is subject to the creditworthiness of the claims payer and the likelihood and timing of payment, for a fixed payment CBP, can, as for the CBA, be precisely predicted.

Therefore, unlike commercial paper, where the identity of the debtor is essential, CBPs can be defined like CBEs, in terms of the payer class, fixed sizes, and maturity dates. They can be made fungible if issued by trust institutions, and traded in a market like treasury bills.

In the case of a non-fungible CBP, the CBP maybe issued by a provider, [like any commercial paper]. In this case it is based on a single-provider bundle.

On the other hand, the CBP may be issued by a trust institution acting as a credit enhancer for the provider consortium. In this case, in order to service the CBP, the trust institution may acquire either a CBE or a CBA from the provider consortium. The advantage of this for the trust institution and the purchasers of the CBP is more security, in that the collateral is now in the hands of the issuer, rather than the provider. The advantage of this for the provider is that burden of administration of the debt is in the hands of the trust institution. If a CBA is used, the providers have also improved their balance sheets.

The CBP may then be sold in the commercial paper marketplace, or more particularly on one of the commercial paper exchanges.

In the case of a fungible CBP, a national marketplace that includes T-Bills is a natural venue, as it would provide some of the services similar to, but not as complete and risk free as those provided by a futures exchange.

In addition, the CBP can involve the holding of the claims bundle by a trust institution acting as third party collateral manager, on behalf of the claims bundle holder. This same institution can also play the role of buyer and holder of the CBP, and so holding the claims bundle collateral for itself.

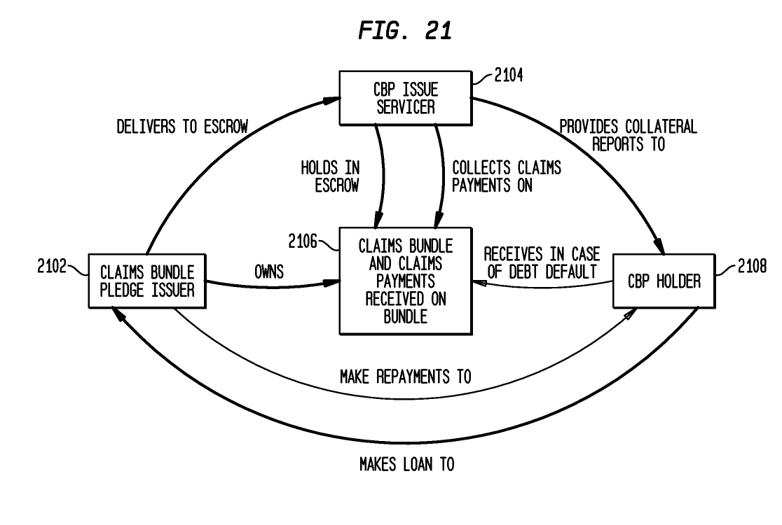

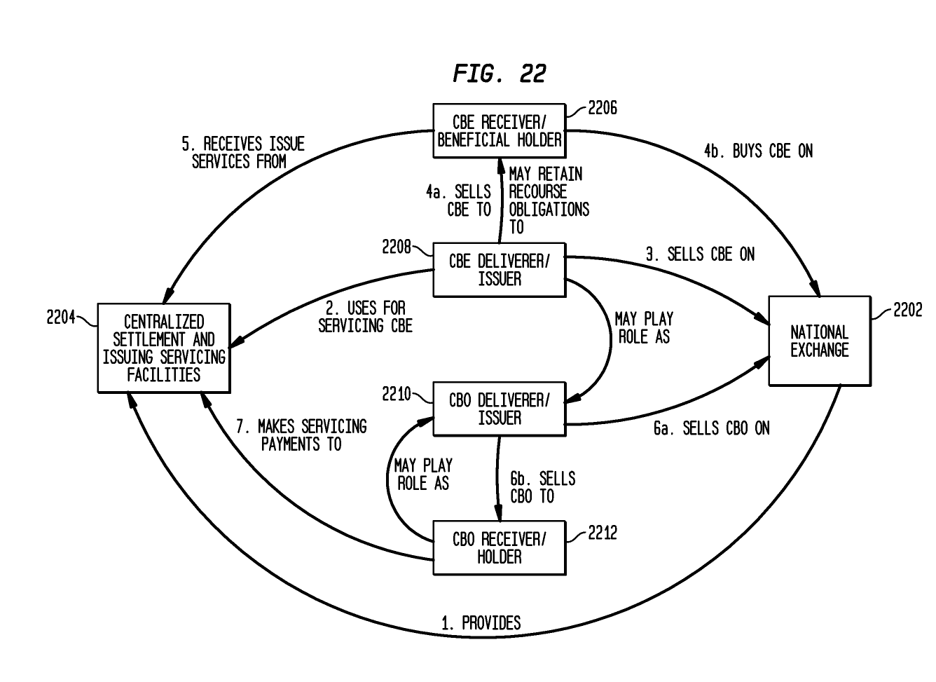

The typical key roles of parties involved with a CBP are described with reference to FIG. 21. A claims bundle pledge issuer 2102 delivers a claims bundle to a CBP issue servicer 2104. The claims bundle pledge issuer 2102 owns the claims bundle and claims payments received on the bundle 2106. The CBP issue servicer 2104 holds the claims bundle and claims payment received on the bundle 2106 in escrow and collects claims payments. The CBP issue holder 2104 provides collateral reports to a CBP holder 2108. The CBP holder 2108 receives the claims bundle and payments received on the bundle 2106 in case of default. The CBP holder 2108 makes loans to and receives repayment from the claims bundle pledge issuer 2102. The economic benefits of the CBP are similar to those of the CBE. Its relative advantage is that it is a more familiar, easily understood, already regulated instrument, in its non-fungible form. Its relative disadvantage is that in its fungible form, it is a less familiar, less easily understood instrument, that might require more regulatory consideration.

The CBP, as non-fungible Asset Backed Commercial Paper, is regulated by the UCC. Insofar as banks issue CBPs on behalf of medical providers, they are also subject to regulation by the FDIC. Insofar as CBPs might be purchased by money market funds, they are subject to regulation by the SEC. A fungible CBP would require changes to some or all of these regulations.

A Claims Bundle Obligation (CBO) is the mirror image of the CBE, in that the receiver of the CBE receives the rights to the payments, while the receiver of the CBO assumes the obligation to make the payments. The asset, actually a negative asset or a liability, is the assumption of the obligation to make the required payments against a claims bundle. CBOs require the deliverer, issuer, or secondary seller to make payment to the receiver or buyer up-front. The CBO can also be structured with the same variants as the CBE, for example, fixed or variable pay, contractual or actual payment dates.

While it is generally uncommon to speak of “selling” a liability, and so having to pay for what is sold, while the buyer receives money for having bought the liability, this way of describing the situation keeps the issuance, or delivery, of the CBO, in the hands of the current holder of the liability. If the CBO is cast as a contract, this oddity goes away: it is simply the case that the contract requires payments from the delivering party at the beginning of the contract, in order to ensure that the value of the contract is zero at its inception.

A CBO is issued to pass on the responsibility to satisfy the entitlements of a CBE, a CBD, or to a buyer who intermediates and adds value as an aggregator and payer of a claims bundle. The value add for the market is the substitution of a higher quality payer for lesser quality payers.

The claims payers associated with a bundle cannot free themselves of the ultimate obligation of paying the claims, without the consent of the claims makers, or without significant changes in insurance practices and law which the use of CBIs may later facilitate. Similarly, without either agreement from the holders of a CBE or the regulatory permission for fungibility between payers of exchange traded CBEs, the obligation assumed by the holder of a CBO would be with recourse to a CBE issuer or the previous claims bundle payer, depending on which directly underlies the CBO.

Thus, initially, all CBOs can be sold With Recourse for the claims makers to the claims payers and/or CBE issuers. Without Recourse CBOs could be must useful mechanisms for restructuring health care funding.

In addition, while the CBO transfers the obligations from the CBE issuer to the CBO holder, the CBE and it rights remain in the hands of its beneficial holder.

The receiver or buyer of a CBO must be a financial institution, with the same or better creditworthiness than the previous CBI payer or claims bundle payer. For example, a bank with the need to add liquidity to its portfolio might buy CBOs, getting cash now in return for making payments later. With the need to make short term loans to use cash, it might issue, sell, or deliver CBOs.

In order for the CBO to be a cost effective instrument, the issue servicer of the CBO would need to be the issue servicer of the underlying instrument, with the payments involved in servicing the claims bundle assumed by the CBO buyer.

The typical key roles of parties involved with a CBO are described with reference to FIG. 22. A national exchange 2202 provides centralized settlement and issue servicing facilities 2204. A CBE receiver/beneficial holder 2206 receives issue services from the centralized settlement and issue servicing facilities 2204. The CBE deliverer/issuer 2208 sells the CBE to and may retain recourse obligations to the CBE receiver/beneficial holder 2206. The CBE receiver/beneficial holder 2206 buys CBEs and the CBE deliverer/issuer 2208 sells CBEs on the national exchange 2202.

A CBO deliverer/issuer 2210 sells CBOs to a CBO receiver/holder 2212. The CBE deliverer/issuer 2208 may play the role of CBO deliverer/issuer 2210. The CBO receiver/holder 2212 makes servicing payments to the centralized settlement and issue servicing facilities 2204 and may also play the role of CBO deliverer/issuer 2210.

The benefit economics of a CBO for the issuer is that the issuer wishes to commit immediate cash in return for transferring to the buyer the obligation to pay somewhat higher payments in the future. For the buyer, the benefit of the CBO is the opportunity to use a lesser amount of currently available and unneeded cash in the place of paying somewhat more in the future. For the marketplace, the quality of the party obligated to make claims payment related to CBIs is improved.

On a larger scale, the use of CBOs provides further liquidity to health care funding, and further opens the current restrictive and stifling bilateral healthcare funding arrangements that stress the working capital of the primary players in the healthcare marketplace. CBOs are subject to the same regulatory venues as CBEs or CBDs. They would be unwieldy to manage without a national marketplace and effective, centralized issue servicing and clearing and settlement facilities.

Table 8 shows the various ways in which one financial instrument in the CBI family may be used as the basis for another, and how they might legally be cast.

Variable attributes enumerated in Tables 9-13 can be used to construct long term and fungible instruments from the basic elements of the short term instruments describe herein. A long-term CBI is most easily based on a fungible claims bundle, with a negotiated single payment date at the maturity (or final settlement date) of the instrument. The term of a CBI that is based on a non-fungible claims bundle is effectively limited by the natural term of the bundle—the last line item in the last claim to pay taking about 90 days, with an average time to pay of about 60 days. As a result, a claims bundle account, as a true sale, cannot be made long term in a straightforward way.

Tables 9-13 illustrate CBI Feature Dimensions and Parameter Values. These Tables organize the variable intrinsic attributes of claims bundle instruments into a set of aspects, and within aspects into dimensions, and for each dimension, it enumerates the values that parameters in that dimension can take.

Each aspect is in a separate table (Table 9 the Aspect is Payments; Table 10 the Aspect is Contractual Features; Table 11 the Aspect is Bundle Element Features; Table 12 the Aspect is Bundle Element Provider; and Table 13 the Aspect is Bundle Element Claims Payers). An Aspect, such as the structure of the payments that will be received by the holder, is a facet or point of view on the instrument, the nature of the instrument when seen with a particular concern in mind.

Each Aspect is composed of dimensions. Each dimension concerns a different kind of information about the instrument that will be of concern from the point of view of that aspect, such as how the payments are timed.

Each dimension has one or more parameters, and each parameter may have a range of values. For example, in the payment timing dimension, the primary parameter identifies whether the timing is contractual or based on some exogenous event, such as payments by the claims payers. If the timing is contractual, then there is a payment schedule parameter that identifies the time at which each payment is made. Where the parameter values are enumerated, they are defined. Where they are normal scalars, such as dates and numbers, they are taken as understood.

Claims bundle instruments have many other aspects, i.e., can be seen from many other viewpoints, and have many other attributes, than the ones defined here. But the values for these other aspects are dependent on more fundamental features. For example, there is no risk aspect below. The reason is that each dimension of risk, such as counterparty settlement risk, is dependent on other more fundamental features of the instrument.

The basic structure for creating a long term CBI is to replace paid claims with unpaid claims until the natural term of an non-fungible bundle is reached. Early in the term of the instrument, the payments that are made against the claims in the bundle are returned to the issuer, and the paid claims replaced in the bundle with new unpaid claims. If all early claims are treated in this way, then 90 days before the end of the term, the payments against the claims are accumulated to make the payment to the instrument holder.

In this way, the term of an instrument can be as long as was desired, and the credit risk to the holder minimized. In fact, this risk is close to the risk of the short term instrument, since claims payments are returned to the issuer only after new claims have replaced the paid claims. If new claims could not be substituted in the bundle, then the payments will be held in a sinking fund until the maturity value or settlement price was accumulated, at which point the instrument or contract would be paid early.

A similar result can be obtained by periodically replacing the entire claims bundle underlying the instrument as it is paid off or if a claims bundle asset instrument is used to underlie a long term instrument, and is replaced in the same way.

Fungibility and corresponding large issue size are critical factors in minimizing the costs of claims bundle based health care funding.

Fungible Security Instruments

A CBI that is cast as a money market instrument or a long term capital markets debt instrument, that is, not as an asset sale and not as a contract is a fungible security instrument called a CBI security.

A simple fungible instrument can be created merely by issuing a CBI security in a large number of units, since of course all the units are then fungible. However, CBI securities are only fungible within a single issue, and so also within a single instrument issuer. As a result, a meaningful size issue of fungible units of a CBI security requires one or very few issuers. Each such issuer would collect claims bundles from collations of providers acting as bundle originator, and then further aggregate these bundles into buyer's issues large enough to provide a large number of meaningful sized units.

Ideally, a single central issuing authority, such as a Government Sponsored Enterprise, would issue all CBI securities.

In addition, with either a few large issuers or a central issuing authority, variable issue and bundle attributes, as cataloged in the appendix, must be selected to both maximize issue size and to minimize the heterogeneity of bundle elements, from the viewpoint of ease of risk and return analysis of the instrument.

A contract approach to claims bundle instruments eliminates the issuer, replacing issuers with parties authorized by the exchange to write contracts. As a result, all contracts of the same type, for the same dates, are fungible, meaning that multiple “issuing parties” can participate, without the requirement of a central issuing authority.

Claims bundle entitlement swaps would have several advantages over claims bundle security issuance: They would achieve the same level of fungibility as a single issuer would achieve for a claims bundle security. Also, claims bundle entitlement swaps would likely result in a larger usage of the claims bundle health care financing facility, since competition for the business of acquiring claims bundles from bundle originators, and writing swap contracts for the delivery of CBEs is encouraged.

At the same time, a central authority, ideally a government sponsored enterprise, would also be required. However, rather than being responsible for issuance, this entity would only need to serve as the Health Care Funding Trust—the trust entity as the depository and registrar and settlement venue for the claims bundles and payments.

Although illustrative embodiments of the invention are described herein which describe claims data being received from a clearinghouse, it should be understood that claims data can come from sources other than a clearinghouse according to other embodiments of the invention. For example, claims data can be received directly from medical service providers, and/or from insurance companies within the scope of the present invention.

While the invention has been described with reference to illustrative embodiments, it should be understood by those skilled in the art that various other changes, omissions, and/or additions may be made and substantial equivalents may be substituted for elements thereof without departing from the spirit and scope of the invention. In addition, many modifications may be made to adapt a particular situation or material to the teaching of the invention without departing from the scope thereof. Therefore, it is intended that the invention not be limited to the particular embodiment disclosed for carrying out this invention, but that the invention will include all embodiments, falling within the scope of the appended claims. Moreover, unless specifically stated any use of the terms first, second, etc., do not denote any order of importance, but rather the terms first, second, etc. are used to distinguish one element from another.

TABLE 1
Distributed System Services Platform - Part 1
Hardware and Systems Software

| | Requirements | | |
|---|---|---|---|
| Platform | | Language | Reference |
| Element | Services Offered | Features | Product |
| Hardware | Enables processes to share a | completely | IBM System p |
| | cluster of multiple CPUs and | documented | |
| | memory spaces, across | with product | |
| | multiple hardware devices, | | |
| | which may be located at long | | |
| | distances from each other. | | |
| Operating | Enables processes to be | completely | the AIX |
| System | moved from one CPU and | documented | operating |
| | memory space to another | with product | system |
| | within such a cluster. | | |

TABLE 2
Distributed System Services Platform - Part 2: Standard Middleware

| | Requirements | | |
|---|---|---|---|
| Platform Element | Services Offered | Language Features | Reference Product |
| Database | Enables reliable | SQL and extensions of | IBM DB2, ORACLE; |
| Management | transactional* coordination of | SQL, ISO compliant | IBM InfoSphere |
| | access to data from multiple | metadata modeling | Information Server |
| | processes, and the | | |
| | transparent distribution of | | |
| | the data | | |
| Interprocess | Enables reliable queuing of | WebSphere MQ's | IBM WebSphere |
| Communications | communications, and | Command set | MQ |
| | transactional* coordination of | | |
| | data access and | | |
| | communications | | |
| User Interface | Centralized management of | Cascading Style Sheets | Lotus Expeditor, |
| | client side rendering and | (css), HTML, XML and | WebSphere Portlet |
| | navigation management | Wysiwyg | Factory |
| | Standard communications | | |
| | support accessible on server | | |
| | side to other software tools | | |
| External Computer | Predefined adaptors for many | Declarative Format | WebSphere |
| Communications | communications protocols. | Mapping | Message Broker |
| | supports both file and | | |
| | message communications | | |
| Report Writing | Web access, report definition | Style Sheets, Wysiwyg | Crystal Reports |
| | management, report schedule | and SQL | |
| | management | | |

TABLE 3
Distributed System Services Operating Platform - Part 3: Service Oriented Middleware

| | Requirements | | |
|---|---|---|---|
| Platform Element | Services Offered | Language Features | Reference Product |
| Service Request | Message Routing based on | Declarative Message Flow | WebSphere |
| Communications | rules, Relational Database | Definitions | Message Broker |
| | Access | | |
| Static Reference | Control of the Business | Declarative Data | Golden Source |
| Information | Processes and referential | Dependency Specifications, | Parties |
| Management | integrity for changing | Declarative Business Process | |
| | reference data. | Controls for changing | |
| | Relational Database Access | reference data | |
| Business | Control of the Business | State Transition, declarative | XTG X-Ecutor |
| Transaction | Processes | event based | |
| Execution | | implementation. Unified | |
| | | Modeling Language Driven | |
| Persistence of | Referential integrity for | XML | XTG X-Poster |
| Business Object | changing the state of | | |
| State Changes | business objects that reflect | | |
| | rights and responsibilities | | |
| | between parties. | | |
| | Relational Database Access | | |
| Systems | System monitoring and | Common Based Events (CBE) | Tivoli Omegamon |
| Management | health | | |

TABLE 4
Claims Bundle Instrument Types Summary

| | | | Fungible | |
|---|---|---|---|---|
| | Short Term | Long Term | Product | Likely U.S. Regulatory |
| Sale Conveyance | Product Name | Product Name | Names | Venue(s) |
| Receivables Account of | Claims Bundle | Long-Term | probably | CBA - UCC |
| Acknowledged Claims | Account (CBA) | Claims Bundle | not | LCBA unknown |
| Bundle | | Account (LCBA) | possible | |
| Guaranteed Rights to | Claims Bundle | Long-Term | FCBE | (F)CBE - UCC, CFTC or |
| Some or All Payments on | Entitlement | Claims Bundle | FLCBE | Treasury (F)LCBE - CFTC or |
| Acknowledged Claims | (CBE) | Entitlement | | Treasury (the CFTC allow |
| Bundle | | (LCBE) | | fungible instruments only) |
| Promise to Make Future | Claims Bundle | Long-Term | FCBP | CBP - UCC (collateralized |
| Payments with | Pledge (CBP) | Claims Bundle | FLCBP | commercial paper) (also SEC if |
| Acknowledged Claims | | Pledge (LCBP) | | held in money market fund) |
| Bundle as Collateral | | | | LCBP - SEC (collateralized |
| | | | | debt obligation) |
| Assumption of Obligation | Claims Bundle | probably not | FCBO | CFTC |
| for Payments on | Obligation | possible | | |
| Acknowledged Claims | (CBO) | | | |
| Bundle | | | | |

TABLE 5
Intrinsic Claims Bundle Attributes

| Name | Definition |
|---|---|
| Providers | The health care providers making the claims in the bundle; |
| | names and Ids of Providers |
| Payors | The entities responsible for payment on the claims; |
| | names and Ids of Payors |
| Projected | Expected Date of receipt of last claims payment |
| Completion | |
| Projected | Expected Date of First payment on account |
| Delivery | |
| Start | |
| Actual | The date on which final payment actually made |
| Delivery | |
| Completion | |
| Actual | The date on which first payment actually made |
| Delivery | |
| Start | |
| Original | The sum of the net amounts of the claims in the bundle |
| Bundle Net | |
| Amount | |
| Payments | The amount already paid for the claims in the bundle |
| Received | |
| Remaining | The original net amount minus payments received |
| Bundle Net | |
| Amount | |
| Claims in | Count and identity of claims in the bundle |
| Bundle | |

TABLE 6
Payment Type Definitions

| Payment Parameter | |
|---|---|
| Value | Definition |
| Payment Determinacy - | The amount of payment expected from the |
| Fixed | CBE is fixed. |
| Payment Determinacy - | The amount of payment expected from the |
| Variable | CBE depends on how much of the Claims in |
| | the CBE are actually paid by the claims |
| | payers. |
| Payment Timing - | The date of each payment from the CBE is |
| Contractual | fixed. In the simplest case, there will be only |
| | one payment. |
| Payment Timing - | The dates of payments expected from the CBE |
| Actual | depend on when the claims CBE is actually |
| | paid by the claims payers. |

TABLE 7
CBE subtypes by Payment Type

| Payment | | |
|---|---|---|
| Determinacy | Payment Timing | CBE Payment Type |
| Fixed | Contractual | Fixed Contractual |
| Fixed | Actual | Fixed Actual |
| Variable | Contractual | not possible |
| Variable | Actual | Variable Actual |

TABLE 8
Ways in which one CBI-family financial instrument may be used as the basis for another

| Marketable | May be a | May be Legally | May be issued and | Issuer Support |
|---|---|---|---|---|
| Instrument | Transform of a | Cast as a | traded | Institution |
| CBA | claims bundle | Asset Sale | Private Placement, | Law Firm, Trust |
| | | | Accounts Receivables | Company, Insurer |
| | | | Exchange | |
| CBE | claims bundle, | Asset Sale | Private Placement, | Trust Company, |
| | CBA | Debt | Money Market | Insurer, Exchange |
| | | Instrument | Exchange, | Supported and/or |
| | | Contract | Swaps Exchange | Government |
| | | | | Sponsored Entity |
| CBP | claims bundle, | Debt | Private Placement, | Trust Company, |
| | CBA, CBE | Instrument | Money Market | Exchange Supported |
| | | | Exchange | and/or Government |
| | | | | Sponsored Entity |
| CBO | claims bundle, | Contract | Private Placement, | Trust Company, |
| | | | | Insurer, Exchange |
| | CBA, CBE, CBP | Derivative | Swaps& Derivatives | Supported and/or |
| | | | Exchange | Government |
| | | | | Sponsored Entity |

TABLE 9
Aspect = Payments
Payments Dimensions and Parameter Values

| | Parameter | Applicable CBI | |
|---|---|---|---|
| Dimension | Values | Types & Subtypes | Definition/Discussion |
| Timing | Contractual | CBE, CBP | instrument payments made at preset times |
| | Actual | CBA, CBE, CBO | Instrument payments made when claims |
| | | | payments received |
| Determinacy | Fixed | CBE, CBP, CBO | Amount paid on instrument specified as part of |
| | | | contract |
| | Variable | CBA, CBE, CBO | Amount paid depends on amount received from |
| | | | claims payers |
| Payment | None - usually | CBA, CBE | Payment is only received if received from claims |
| Assurance | applies to | (CBO) | payer |
| Method | variable | | (a CBO could call for responsibility only for |
| | payment | | payments approved in EOBs by the claims payer) |
| | determinacy | | |
| | Reserve | CBE, CBP | Issuer has a reserve as a percentage of issued |
| | | | value to cover some issue payments |
| | Sinking Fund | CBP | Collateral Manager holds payments on bundle |
| | | | until debt is satisfied |
| | Overfunding | CBE, CBP | Net Value of claims bundle greater than fixed |
| | | | value assigned to CBI |
| | Repurchase | CBA | Overfunded CBA is resold to issuer when fixed |
| | Agreement | | value of CBA has been paid form claims proceeds |

TABLE 10
Aspect = Contractual Features
Instrument Contractual Dimensions and Parameter Values

| | | | |
|---|---|---|---|
| | Parameter | Applicable CBI | |
| Dimension | Values | Types & Subtypes | Definition/Discussion |

| | | |
|---|---|---|
| CBI Type | CBA, CBE, CBP, | The CBI type defines the contractual relationship between issuer and holder |
| | CBO | in business terms, not legal terms. The same type might be cast in several |
| | | different ways legally: for example, a CBE - Claims Bundle Swap |

| | | | |
|---|---|---|---|
| Interest | Perfected | CBA, CBE, CBP | Claims bundle is liened in favor of holder or |
| Perfection | | | depository/registrar |
| | Non-Perfected | CBA, CBE, CBP, CBO | Claims bundle is not liened |
| Unit Size | Issue Size | CBA, CBE, CBP, CBO | size of the unit = size of issue Variable payment |
| | | | determinacy leads to unrounded issue size |
| | Unitized | CBE, CBP, CBO | Issue delivered in units Must be the case for a listed |
| | | | swap |
| Fungibility | Non-Fungible | CBA, CBE, CBP | Each claims bundle is a unique issue. |
| | Fungible | CBE, CBP, CBO | Many different claims bundles can be part of same |
| | | | issue. (Requires Unitized Unit Size). |
| Term Length | Natural Term | CBA, CBE, CBP, CBO | Term of instrument depends on payment of claims in |
| | | | a non-fungible bundle |
| | Extended | CBE, CBP, CBO | Term of instrument longer than payment of claims |
| | Money Market | | but less than one year |
| | Extended | CBE, CBP, CBO | Term of instrument longer than payment of claims |
| | Capital Market | | and greater than one year |
| Creditor | No Recourse | CBA, CBE | Provider and/or Issuer Creditor has no recourse to |
| Recourse | | | assets underlying instrument |
| | Recourse | CBP, CBO | Provider and/or Issuer Creditor has recourse to assets |
| | | | underlying assets |
| Maturity/Final | Indeterminate | CBA, CBE | The instrument maturity date/contract final |
| Settlement | | | settlement date is dependent on final payment on |
| Determinacy | | | bundle |
| | Determined | CBA, CBE, CBP, CBO | The instrument maturity date/contract final |
| | | | settlement date is contractually fixed |

TABLE 11
Aspect = Bundle Element Features
Bundle Element Feature Dimensions and Parameter Values

| | Parameter | Applicable CBI | |
|---|---|---|---|
| Dimension | Values | Types & Subtypes | Definition/Discussion |
| Fungibility | Non-Fungible | CBA, CBE, CBP, | The claims and line items in the bundle are fixed |
| | | CBO | when the bundle is created |
| | Fungible | CBE, CBP, CBO | The claims or line items in bundle can be changed |
| | | | as long as they conform to a specification |
| Element | Claim Level | CBA, CBE, CBP, | The items in the bundle are complete claims |
| Granularity | Granularity | CBO | |
| | Line Item Level | CBE, CBP, CBO | The items in the bundle are line items within |
| | Granularity | | claims, so that a claim, as a whole, may be only in |
| | | | part in the bundle |
| Element Service | Non-Specified | CBA, CBE, CBP, | Nature of Services for which claim is made is not |
| Type | | CBO | specified |
| | Specified | CBA, CBE, CBP, | Nature of Services for which claim is made is |
| | | CBO | specified, May require line-item granularity, |
| | | | depending on specificity of service type |

TABLE 12
Aspect = Bundle Element Providers
Bundle Element Provider Dimensions and Parameter Values

| | Parameter | Applicable CBI Types & | |
|---|---|---|---|
| Dimension | Values | Subtypes | Definition/Discussion |
| Creditworthiness | Homogeneous | CBA, CBE, CBP, CBO | The creditworthiness of providers is |
| | | | provided as an attribute of the bundle |
| | Non- | CBA, CBE, CBP, CBO | The average creditworthiness of providers |
| | Homogeneous | | is provided as an attribute of the bundle, |
| | | | and that of each provider is available |
| | | | information |
| | Not Identified | CBE, CBP, CBO | The creditworthiness of providers is not |
| | | | provided as an attribute of the bundle |
| Service Type | Homogeneous | CBA, CBE, CBP, CBO | The nature of the service of providers (e.g. |
| | | | general hospital, medical trials laboratory) |
| | | | is provided as an attribute of the bundle |
| | Non- | CBA, CBE, CBP, CBO | The providers in the bundle may deliver |
| | Homogeneous | | different kinds of medical services, and |
| | | | that of each provider is available |
| | | | information |
| | Not Identified | CBE, CBP, CBO | The nature of the service of providers is |
| | | | not provided as an attribute of the bundle |
| Domicile | Homogeneous | CBA, CBE, CBP, CBO | The single state of domicile of all providers |
| | | | is provided as an attribute of the bundle |
| | Non- | CBA, CBE, CBP, CBO | The state of domicile of each provider may |
| | Homogeneous | | be different, and that of each provider is |
| | | | available information |
| | Not Identified | CBE, CBP, CBO | The state of domicile of providers is not |
| | | | provided as an attribute of the bundle |
| Domicile Region | Homogeneous | CBA, CBE, CBP, CBO | The single geographic region of domicile |
| | | | of all providers is provided as an attribute |
| | | | of the bundle |
| | Non- | CBA, CBE, CBP, CBO | The geographic region of domicile of each |
| | Homogeneous | | provider may be different, and that of |
| | | | each provider is available information |
| | Not Identified | CBE, CBP, CBO | The geographic region of domicile of |
| | | | providers is not provided as an attribute of |
| | | | the bundle |
| Legal | Homogeneous | CBA, CBE, CBP, CBO | The single type of legal organization (e.g., |
| Organization | | | for profit corporation) of all providers is |
| | | | provided as an attribute of the bundle |
| | Non- | CBA, CBE, CBP, CBO | The type of legal organization of each |
| | Homogeneous | | provider may be different, and that of |
| | | | each provider is available information |
| | Not Identified | CBE, CBP, CBO | The type of legal organization of providers |
| | | | is not provided as an attribute of the |
| | | | bundle |

TABLE 13
Aspect = Bundle Element Claims Payers
Bundle Element Payer Dimensions and Parameter Values

| | Parameter | Applicable CBI Types & | |
|---|---|---|---|
| Dimension | Values | Subtypes | Definition/Discussion |
| Creditworthiness | Homogeneous | CBA, CBE, CBP, CBO | The creditworthiness of payers is |
| | | | provided as an attribute of the bundle |
| | Non- | CBA, CBE, CBP, CBO | The average creditworthiness of payers is |
| | Homogeneous | | provided as an attribute of the bundle, |
| | | | and that of each payer is available |
| | | | information |
| | Not Identified | CBE, CBP, CBO | The creditworthiness of payers is not |
| | | | provided as an attribute of the bundle |
| Business Type | Homogeneous | CBA, CBE, CBP, CBO | The nature of the business of payers (e.g., |
| | | | Medicare, HMO, pharmaceutical, mutual |
| | | | insurance company) is provided as an |
| | | | attribute of the bundle |
| | Non- | CBA, CBE, CBP, CBO | The payers in the bundle may be in |
| | Homogeneous | | different businesses, and that of each |
| | | | payer is available information |
| | Not Identified | CBE, CBP, CBO | The nature of the business of payers is not |
| | | | provided as an attribute of the bundle |
| Domicile | Homogeneous | CBA, CBE, CBP, CBO | The single state of domicile of all payers is |
| | | | provided as an attribute of the bundle |
| | Non- | CBA, CBE, CBP, CBO | The state of domicile of each payer may |
| | Homogeneous | | be different, and that of each payer is |
| | | | available information |
| | Not Identified | CBE, CBP, CBO | The state of domicile of payers is not |
| | | | provided as an attribute of the bundle |
| Domicile Region | Homogeneous | CBA, CBE, CBP, CBO | The single geographic region of domicile |
| | | | of all payers is provided as an attribute of |
| | | | the bundle |
| | Non- | CBA, CBE, CBP, CBO | The geographic region of domicile of each |
| | Homogeneous | | payer may be different, and that of each |
| | | | payer is available information |
| | Not Identified | CBE, CBP, CBO | The geographic region of domicile of |
| | | | payers is not provided as an attribute of |
| | | | the bundle |
| Legal | Homogeneous | CBA, CBE, CBP, CBO | The single type of legal organization (e.g., |
| Organization | | | for profit corporation) of all payers is |
| | | | provided as an attribute of the bundle |
| | Non- | CBA, CBE, CBP, CBO | The type of legal organization of each |
| | Homogeneous | | payer may be different, and that of each |
| | | | payer is available information |
| | Not Identified | CBE, CBP, CBO | The type of legal organization of payers is |
| | | | not provided as an attribute of the bundle |

What is claimed is:

1. A computer implemented method of automating healthcare funding exchange, comprising:
bundling medical claim receivables from at least one issuer into a bundle of claims;
offering said bundle for sale on an automated exchange via at least one user interface to said exchange;
maintaining a database of buy orders from parties who have submitted a bid on said bundle and sell orders from parties who have submitted an offer to sell said bundle; and
automatically matching said buy orders with said sell orders.

2. The method of claim 1, comprising:
identifying a buyer from said parties who have submitted a bid on said bundle in response to said matching;
identifying a seller from said party who has submitted an offer to sell said bundle in response to said matching;
executing a trade of said bundle by automatically communicating with a buyer said buyer and said seller via said at least one user interface; and
settling a trade of said bundle by receipt of payment from the buyer in an amount of an accepted bid and receipt of the payment in an account of the seller.

3. The method of claim 2, wherein said settling a trade includes;
perfecting a lien interest in said bundle; and
conveying said perfected lien interest to said buyer.

4. The method of claim 1, comprising:
integrating said database with a source of claims data to support flow of claim data in said database.

5. The method of claim 1 comprising:
monitoring the correct use of claims payment processes by medical service providers and insurers involved with said bundle to establish a set of rating data for publication of said medical service providers and insurers according to said correct use;
communicating said set of rating data to said parties interested in buying said bundle to enable valuation of said bundle.

6. A computer implemented method of trading medical receivables, comprising:
offering bundles of medical receivables claims issued as financial instruments to a bidding process on a computer network;
providing historical data by which valuation may be performed to said bidding process; and
receiving bids for said bundles of medical receivables from bidders in the group consisting of factors, investors and financing entities.

7. The method of claim 6, comprising:
integrating said bidding process via said computer network with at least one source of claims data to allow communication of claims data from said at least one source of claims data to said bidding process via a claims bundle issuance component.

8. An automated healthcare funding exchange system, comprising:
a distributed systems services platform including at least one networked processer and memory;
a structure for creating service domain systems in communication with said platform; and
a claims bundle issuance component in communication with said structure, said claims bundle issuance component configured to identify bundles of an issuer's claims for a buyer and to issue said bundles as a healthcare funding instrument in response to agreement by said issuer to offer for sale said bundles.

9. The system of claim 8, comprising:
said claims bundle issuance component configured to:
receive issue instructions from an issuer via a computer;
construct a bundle in response to said issue instructions when said claims are available;
receive buying instructions from a buyer via a computer;
identify a bundle and bid for purchase of said identified bundle in response to said buying instructions; and
generate a notification of purchase execution in response to acceptance of said bid for purchase.

10. The system of claim 8, comprising:
a claims bundle asset servicing component in communication with said structure, said bundle asset service component configured to create said bundles for issuance and to coordinate payment for holders of said bundles.

11. The system of claim 10, comprising:
said claims bundle asset servicing component configured to:
make a claim available for bundling in response to receipt of a claim record from a claims clearing house;
create issuer bundles and combine issuer bundles into a holders bundle;
compute a value for said bundles;
adjust said value in response to declared intentions to pay by insurers; and
inform issuers and holders of forthcoming payments.

12. The system of claim 8, comprising:
a claims bundle settlement component in communication with said structure, said claims bundle settlement component configured to coordinate changes in status of claims bundles and settlement payments between trading parties in response to issuance or trading of said claims bundles.

13. The system of claim 12, comprising:
said claims bundle settlement component configured to:
place a lien on a claims bundle in favor of said buyer in response to a valid authorization; and
remove a lien on said claims bundle in favor of a previous bundle holder.

14. The system of claim 12, comprising:
said claims bundle settlement component configured to:
record transfer of ownership of said claims bundle to said buyer from said issuer; and
coordinate payment from said buyer to said issuer.

15. The system of claim 8, comprising:
a servicing coordinator component in communication with said structure, said servicing coordinator component configured to manage privileges, profiles and accounting rules for parties involved in a claims bundle transaction.

16. The system of claim 15, comprising:
said servicing coordinator component configured to:
record profiles of new parties in a database; and
set up accounts appropriate for said new parties according to a type of said new party.

17. The system of claim 8, comprising:
a claims bundle trading component in communication with said structure, said claims bundle trading component configured to facilitate trades of previously issued claims bundles.

18. The system of claim 17, comprising:
said claims bundle trading component configured to:
accept buy orders from parties interested in purchasing claims bundles;
accept sell orders from parties interested in selling said claims bundles;
match a buyer and a seller in response to receiving said buy orders and said sell orders;
enable execution of a claims bundle trade in response to said matching;
maintain and publish market data including information regarding open orders; and
send notification of trade executions to parties involved with said claims bundles.

19. A computer implemented system of automating healthcare funding exchange, comprising:
means for bundling medical receivables from at least one issuer into a bundle of claims;
means for offering said bundle for sale on an automated exchange via at least one user interface to said exchange;
means for maintaining a database of buy orders from parties interested in buying said bundle and sell orders from parties interested in selling said bundle; and
means for automatically matching said buy orders with said sell orders.

20. The computer implemented system of claim 19, comprising:
means for identifying a buyer from said parties interested in buying said bundle in response to said matching;
means for identifying a seller from said parties interested in selling said bundle in response to said matching; and
means for settling a trade of said bundle by automatically communicating with a buyer said buyer and said seller via said at least one user interface.

21. A method of automating healthcare funding exchange implemented in a computer system having a processor, at least one user interface, and a database, comprising:
a means for defining a healthcare funding instrument by bundling either healthcare assets or liabilities into such an instrument from at least one provider into a bundle offered for sale on an automated exchange over said at least one user interface;
storing in said database buy orders, bids, and indications of interest from parties interested in buying said instrument; and storing in said database sell orders, offers, and indications of interest from parties interested in selling bundled instruments;
facilitating, via said at least one user interface, submission of new orders, modifying or deleting of buy orders and modifying or deleting of sell orders bids and indications of interest in said database; and
matching, via said processor, new or modified buy orders offers or indications of interest from parties interested in buying said bundle of claims with new or modified sell orders from parties interested in selling bundled claims.

22. The method of claim 21, wherein said healthcare funding instruments are selected from the group consisting of medical receivables, medical payables, health care service claims, future cash health care services, and fungible (transferable) health care insurance.

23. The method of claim 21, wherein said healthcare funding instruments are defined by selecting from a predefined set of types of business rights and corresponding obligations holding between the issuer and the holder of the instrument.

24. The method of claim 21, wherein said healthcare funding instruments are defined by using a template of allowable parameters or attributes, based on the nature of the business relationship embodied in the instrument, and selecting values or value ranges for each of the parameters or attributes in the selected set of these parameters or attributes.

25. The method of claim 23, wherein said predefined set of types of business rights and corresponding obligations holding between the issuer and the holder of the instrument are selected from the group consisting of asset sale, entitlement to payments from the underlying health care asset bundle, obligations to make payments on behalf of underlying health care liability bundle, and debt backed by health care assets.

26. The method of claim 24, wherein said templates and attributes are those specifically contained in predetermined tables and rules.

27. The method of claim 7, wherein said at least one source of claims data is selected from the group consisting of medical claims clearinghouses, providers and payers.

28. The method of claim 4, wherein said source of claims data is selected from the group consisting of medical claims clearinghouses, providers and payers.

29. The system of claim 13, wherein said valid authorization is provided by an issuer.

30. The system of claim 13, wherein a valid authorizer of said lien is identified in said instrument.
